(19) United States
(12) Patent Application Publication
(10) Pub. No.: US 2008/0123343 A1
(43) Pub. Date: May 29, 2008

(54) Light source device, image display device, optical element and manufacturing method thereof

(76) Inventors: Tatsuru Kobayashi, Kanagawa-ken (JP); Ryosuke Nakagoshi, Kanagawa-ken (JP); Ryusaku Takahashi, Kanagawa-ken (JP); Isamu Nakayama, Kanagawa-ken (JP); Takayuki Kashiwagi, Kanagawa-ken (JP); Eiji Kubo, Kanagawa-ken (JP); Naoya Okamoto, Kanagawa-ken (JP)

Correspondence Address: THE NATH LAW GROUP, 112 South West Street, Alexandria, VA, 22314, US

(21) Appl. No.: 11/812,993

(22) Filed: Jun. 22, 2007

(30) Foreign Application Priority Data
Jun. 23, 2006 (JP) P2006-174635
Oct. 31, 2006 (JP) P2006-296591
Oct. 31, 2006 (JP) P2006-296602
Oct. 31, 2006 (JP) P2006-296612
Mar. 30, 2007 (JP) P2007-094525

(51) Int. Cl. F21V 7/04; B24B 1/00

(52) U.S. Cl. 362/298; 451/29

(57) ABSTRACT

A light source device includes a solid light emitting element 1 having a reflection film on the back side, first and second reflection surfaces 2, 3 opposing each other in parallel and substantially perpendicular to a front surface of the solid light emitting element 1 and a third reflection surface 4 substantially perpendicular to the first and second reflection surfaces 2, 3 and opposing the front surface of the solid light emitting element 1. The third reflection surface 4 is inclined to the front surface of the solid light emitting element 1. The reflection film of the element 1, the first, second and third reflection surfaces 2, 3, 4 do constitute a closed polyhedron having an emission opening 5 smaller than a light emitting surface of the element 1. Light emitted from the element 1 is emitted to an outside through the emission opening 5.

### BACKGROUND OF THE INVENTION

1. Field of the Invention

The present invention relates to a light source device for illuminating a spatial light modulating element in an image display device or the like, an image display device having such a light source device, an optical element forming such a light source device and a manufacturing method of the above optical element.

2. Description of Related Art

In prior art, there has been proposed an image display device that includes a spatial light modulating element to be illuminated by a light source device and further produces an image from light modulated by the spatial light modulating element. In the image display device, the spatial light modulating element displays a display image and modulates illumination light corresponding to the so-displayed image. The modulation light modulated by the spatial light modulating element is focused into an image by an imaging optics. This image is displayed on a display unit, for example, screen.

As the light source device for the above image display device, a light source device using a solid light emitting element disclosed in Japanese Patent Application Laid-open No. 7-66455 is proposed. The solid light emitting element corresponds to light emitting diode (LED), semiconductor laser diode (LD), electroluminescence element (EL) and so on.

For the image display device, there are known light source devices each of which includes an integrator optical system in order to illuminate a spatial light modulating element uniformly, as shown in FIGS. 1 and 2. The integrator optical system is provided to uniformize luminance distribution of illumination light from a light source.

In the fly-eye lens integrator optical system of FIG. 1, the luminance distribution of illumination light for illuminating a spatial light modulating element 103 can be uniformized by letting the illumination light through fry-eye lenses 101, 102 having a number of small lenses in arrangement.

In the rod integrator optical system of FIG. 2, an internal reflection is repeated by letting the illumination light through a prismatic rod 104, so that the luminance distribution of illumination light is uniformized. In the rod integrator optical system, that is, an image of a light source 105 is produced on one end face (i.e. incident surface) of the rod 104. Instead, the light source 105 is positioned to make a close contact with the end face of the rod 104. In operation, the light emitted from the light source 105 is propagated in the rod 104 while making internal reflections (total reflection) in the rod 104 and subsequently, the light is emitted to an outside through the other end face (or an emission end face) of the rod 104. By producing an image of the emission end face of the rod 104 on a spatial light modulating element 103 as an object to be illuminated, there can be obtained illumination light whose luminance distribution is uniform advantageously.

### SUMMARY OF THE INVENTION

In the image display device mentioned above, high-luminance image displaying can be accomplished by illuminating a spatial light modulating element at higher luminance. In this view, it is contemplated to increase an output of a light source. However, if a light source is increased in its output, then there are cause various disadvantages, for example, increasing of a power consumption, increasing of calorific value, large-sized installation, etc. In order to illuminate the spatial light modulating element with high luminance, therefore, it is required to improve the utilization efficiency of light emitted from a light source without increasing its output.

In the field of optics, meanwhile, there is known the “Helmholtz-Lagrange invariant” defined as

N u y=N′u′y′

where “N” and “N′” are refractive indexes, “u” and “u′” are angles of light rays, and “y” and “y′” are image heights. This relationship is always established between two zones on both sides of an optical surface (e.g. lens).

Further, if describing the image heights (heights of object) “y”, “y′” as an area (S) and the light rays' angles “u”, “u′” as a solid angle (θ), then the above relationship can be grasped as “relationship of etendue (E'tendue)” and further restated that respective “etendue” values are unchangeable in two zones interposing the optical surface therebetween. The etendue “E” is represented by

E=p S sin²θ.

This relationship is invariant through a plurality of optical systems and is applicable to a relationship between an object and its image. Accordingly, the above relationship is established in between an illumination light source and an object to be illuminated (spatial light modulating element) and further established in the above-mentioned light source device, as well.

In the rod-integrator optical system using the prismatic rod 104 (see FIG. 2), for instance, an irradiation angle of light rays (light beams) from the emission end face of the rod 104 is equal to an irradiation angle of light rays from the light source 105. It should be noted here that the “Helmholtz-Lagrange invariant” is satisfied. Also, the “Helmholtz-Lagrange invariant” is also satisfied in the shown imaging optics that produces an image of the emission end face of the rod 104. Accordingly, the “Helmholtz-Lagrange invariant” comes into effect throughout the whole illumination optical system shown in the figure.

Suppose here that the specification of an illumination optical system power (i.e. image height “y′” and light ray angle “u′”) is so large in comparison with the specification of a light source (object height “y” and irradiation angle “u”) and the relationship

N u y<N′u′y′

is satisfied. Then, it means that almost all of light rays emitted from the light source can be taken into the illumination optical system.

In connection, it should be noted that the “Helmholtz-Lagrange invariant” comes into effect in the fly-eye lens integrator optical system (FIG. 1) as well.

In this way, the utilization efficiency of light from a light source in a light source device is determined in accordance with “etendue” that is a function between an emission area of the light source and an irradiation angle of light rays emitted from the light source. That is, the utilization efficiency of light (light rays) emitted from a surface light source having finite dimensions (size) is determined by both an emission area of the light source and an irradiation angle of light therefrom uniquely.

In order to illuminate an object to be illuminated at higher luminance, therefore, it is necessary to either increase an amount of emission light from the light source per unit area or reduce an irradiation angle of light rays from the light source. However, these measures are together directed to improvements in the performance of the light source, which is far from an improvement in the utilization efficiency of light from the light source.

As the illumination optical system directed to an improvement in the utilization efficiency of light from a light source, there are proposed an integrator optical system using a tapered rod and an integrator optical system using a tapered light pipe, as shown in FIGS. 3 and 4. In the integrator optical system using a tapered light pipe having an emission opening larger than the light source 105, the light rays' emission angle “θ′” becomes smaller since the “Helmholtz-Lagrange invariant” comes into effect, as shown in FIG. 3. On the contrary, in the integrator optical system using a tapered light pipe having an emission opening smaller than the light source 105, the light rays' emission angle “θ′” becomes larger since the “Helmholtz-Lagrange invariant” comes into effect, as shown in FIG. 4. In common with these integrator optical systems, there is no change in respective values of etendue. That is, it should be said that the utilization efficiency of light from the light source is not improved in these integrator optical systems.

Additionally, there is proposed a light source device including light emitting diodes (LED) as a light source and a light pipe for introducing light from the light source, which is adapted so as to return unnecessary polarized light inside the light pipe to the light source and subsequently rotate so-returned light (reflection light) LED at 90 degrees by a retardation plate. This light source device is directed to an improvement in the utilization efficiency of light (i.e. improvement of etendue) in addition to the task of a polarization changer. However, since the same device is based on the assumption of completing the polarization change, it is impossible to change the value of etendue to an optional value for improvement.

Further, in these light source devices, it is necessary to maintain the shape of an optical element with high accuracy. Nevertheless, in case of a light source device including an optical element having an acute-angled edge between one surface and another surface, the edge is easy to get chipped to make it difficult to handle the optical element during and after processing.

Under a situation mentioned above, an object of the present invention is to provide a light source device that improves the utilization efficiency of light from a light source and a value of etendue thereby to allow an object, such as spatial light modulating element, to be illuminated at higher luminance without increasing a quantity of emission light per unit area of the light source and without reducing an irradiation angle of light rays from the light source. In case of a light source device including an optical element having an acute-angled edge between one surface and another surface, furthermore, another object of the present invention is to prevent the acute-angled edge from getting chipped thereby facilitating a handling of the optical element during and after processing and maintaining the shape of the optical element with high accuracy. In connection, a further object of the present invention is to provide an image display device using such a light source device as mentioned above.

In order to achieve the above objects, according to the first aspect of the present invention, there is provided an light source device comprising: a solid light emitting element forming a surface emission light source having a reflection film arranged on a back side of the surface emission light source and a light emitting surface arranged on the front side of the surface emission light source; first and second reflection surfaces formed to oppose each other in parallel, the first and second reflection surfaces being substantially perpendicular to a front surface of the solid light emitting element; and a third reflection surface formed to oppose the front surface of the solid light emitting element, the third reflection surface being substantially perpendicular to the first and second reflection surfaces and inclined to the front surface of the solid light emitting element; wherein the reflection film of the solid light emitting element, the first reflection surface, the second reflection surface and the third reflection surface constitute a closed polyhedron having an emission opening defined by a side edge of the third reflection surface on a far side of the front surface of the solid light emitting element, one side edge of the first reflection surface, one side edge of the second reflection surface and one side edge of the reflection film; and the emission opening has an area smaller than an area of the light emitting surface of the solid light emitting element, whereby light generated from the solid light emitting element is emitted to an outside through the emission opening after being either reflected by at least one of the first to third reflection surfaces and the reflection film or unreflected by the first to third reflection surfaces and the reflection film.

According to the second aspect of the present invention, additionally, there is also provided a light source device comprising: a solid light emitting element forming a surface emission light source having a reflection film arranged on a back side of the surface emission light source and a light emitting surface arranged on the front side of the surface emission light source; and an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedron surrounded by the first to fifth surfaces and filled up with a medium having a refractive index larger than a refractive index of a medium surrounding the optical element; wherein the fifth surface has an area smaller than an area of the light emitting surface of the solid light emitting element, whereby light generated from the solid light emitting element enters into the optical element through the first surface and is emitted to an outside through the fifth surface after being either reflected by at least one of the first to fourth surfaces and the reflection film or unreflected by the first to fourth surfaces and the reflection film.

Further, in the third aspect of the present invention, there is also provided a light source device comprising: a solid light emitting element forming a surface emission light source having a reflection film arranged on a back side of the surface emission light source and a light emitting surface arranged on the front side of the surface emission light source; an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedron surrounded by the first to fifth surfaces and filled up with a medium having a refractive index larger than a refractive index of a medium surrounding the optical element; and a light pipe made from an exterior medium having a refractive index larger than the refractive index of the medium in the optical element and successively formed integrally with the optical element at the fifth surface of the optical element, the light pipe having a configuration tapered so as to gradually increase its cross sectional area as departing from the optical element and having a leading surface formed in parallel with the fifth surface to provide an emission end face, wherein the fifth surface has an area smaller than an area of the light emitting surface of the solid light emitting element, whereby light generated from the solid light emitting element enters into the optical element through the first surface and successively enters into the light pipe through the fifth surface after being either reflected by at least one of the first to fourth surfaces and the reflection film or unreflected by the first to fourth surfaces and the reflection film, and finally, the light is emitted to an outside through the emission end face of the light pipe.

Further, according to the fourth aspect of the present invention, there is also provided a light source device comprising: a solid light emitting element forming a surface emission light source having a reflection film arranged on a back side of the surface emission light source and a light emitting surface arranged on the front side of the surface emission light source; an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedron surrounded by the first to fifth surfaces and filled up with a medium having a refractive index larger than a refractive index of an exterior medium surrounding the optical element; and a reflection surface arranged to be substantially parallel with the fourth surface through a small space filled up with a medium having a refractive index smaller than the refractive index of the medium filling the optical element, wherein a gap between a front surface of the solid light emitting element and the optical element is filled up with a medium having a refractive index smaller than the refractive index of the medium filling the optical element, and the fifth surface has an area smaller than an area of the light emitting surface of the solid light emitting element, whereby light generated from the solid light emitting element enters into the optical element through the first surface and is emitted to an outside through the fifth surface after being either reflected by at least one of the first to fourth surfaces, the reflection film of the solid light emitting element and the reflection surface or unreflected by the first to fourth surfaces, the reflection film of the solid light emitting element and the reflection film.

Still further, according to the fifth aspect of the present invention, there is also provided a light source device comprising: a solid light emitting element forming a surface emission light source having a reflection film arranged on a back side of the surface emission light source and a light emitting surface arranged on the front side of the surface emission light source; an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedron surrounded by the first to fifth surfaces and filled up with a medium having a refractive index larger than a refractive index of an exterior medium surrounding the optical element; a reflection surface arranged to be substantially parallel with the fourth surface through a small space filled up with a medium having a refractive index smaller than the refractive index of the medium filling the optical element; and a light pipe made from a medium having a refractive index larger than the refractive index of the medium in the optical element and successively formed integrally with the optical element at the fifth surface of the optical element, the light pipe having a configuration tapered so as to gradually increase its cross sectional area as departing from the optical element and having a leading surface formed in parallel with the fifth surface to provide an emission end face, wherein a gap between a front surface of the solid light emitting element and the optical element is filled up with a medium having a refractive index smaller than the refractive index of the medium filling the optical element, and the fifth surface has an area smaller than an area of the light emitting surface of the solid light emitting element, whereby light generated from the solid light emitting element enters into the optical element through the first surface and successively enters into the light pipe through the fifth surface after being either reflected by at least one of the first to fourth surfaces, the reflection film of the solid light emitting element and the reflection surface or unreflected by the first to fourth surfaces, the reflection film of the solid light emitting element and the reflection film, and finally, the light is emitted to an outside through the emission end face of the light pipe.

According to the present invention, there is also provided an image display device comprising: the light source device of any one of the first to fifths aspects; a spatial light modulating element illuminated by light emitted from the light source device; and an imaging optics that receive light transmitted through the spatial light modulating element thereby to produce an image of the spatial light modulating element.

Further, there is also provided an optical element formed as a polyhedron having a plurality of surfaces and filled up with a solid medium, wherein the surfaces includes a first surface and a second surface between which an acute-angled edge is formed, the second surface being opposed and inclined to the first surface, and the polyhedron has a protecting member attached to the second surface, at least in the vicinity of the acute-angled edge.

Still further, there is also provided a method of manufacturing an optical element formed as a polyhedron having a plurality of surfaces and filled up with a solid medium, the method comprising, in forming an acute-angled edge between a first surface of the surfaces and a second surface of the surfaces, the second surface being opposed and inclined to the first surface: attaching a protecting member to the second surface, at least in the vicinity of the acute-angled edge after grinding the second surface; and forming the first surface by grinding a part of the protecting member and the first surface.

### BRIEF DESCRIPTION OF THE DRAWINGS

FIG. 1 is a side view showing a constitution of a light source device (fly-eye lens integrator) in prior art;

FIG. 2 is a side view showing a constitution of a light source device (rod integrator) in prior art;

FIG. 3 is a side view showing a constitution of a light source device (increasing tapered light pipe) in prior art;

FIG. 4 is a side view showing a constitution of a light source device (decreasing tapered light pipe) in prior art;

FIG. 5 is a perspective view showing a constitution of a light source device in accordance with a first embodiment of the present invention;

FIG. 6 is a sectional view showing a constitution of a solid light emitting element in the light source device of the present invention;

FIG. 7 is a sectional view showing the constitution of the light source device in accordance with the first embodiment of the present invention;

FIG. 8 is a sectional view showing another constitution of the light source device in accordance with the first embodiment of the present invention;

FIG. 9 is a graph showing a relationship between etendue and illuminating intensity in the light source device of the present invention;

FIG. 10 is a sectional view showing a constitution of a light source device in accordance with a second embodiment of the present invention;

FIG. 11 is a sectional view showing a constitution of a light source device in accordance with a third embodiment of the present invention;

FIG. 12 is a sectional view showing a constitution of a light source device in accordance with a fourth embodiment of the present invention;

FIG. 13 is a sectional view showing a constitution of a light source device in accordance with a fifth embodiment of the present invention;

FIG. 14 is a sectional view showing another constitution of the light source device in accordance with the fifth embodiment of the present invention;

FIG. 15 is a sectional view showing a further constitution of the light source device in accordance with the fifth embodiment of the present invention;

FIG. 16 is a sectional view showing a constitution of a light source device in accordance with a sixth embodiment of the present invention;

FIG. 17 is a sectional view showing a constitution of a light source device in accordance with a seventh embodiment of the present invention;

FIG. 18 is a perspective view showing a constitution of a light source device in accordance with an eighth embodiment of the present invention;

FIG. 19 is a longitudinal sectional view showing the constitution of the light source device in accordance with the eighth embodiment of the present invention;

FIG. 20 is a longitudinal sectional view showing a constitution of another solid light emitting element in the light source device of the present invention;

FIG. 21 is a longitudinal sectional view showing a constitution of the light source device of the eighth embodiment, provided with a light pipe;

FIG. 22 is a front view showing a corn angle distribution on a fifth surface and an emission end surface of the light pipe in the light source device of the eighth embodiment;

FIG. 23 is a perspective view showing the constitution of the light source device in accordance with the eighth embodiment of the present invention;

FIG. 24 is a sectional view showing another constitution of the light source device in accordance with the eighth embodiment of the present invention;

FIG. 25 is a sectional view showing a constitution of a light source device in accordance with a ninth embodiment of the present invention;

FIG. 26 is a sectional view showing a constitution of a light source device in accordance with a tenth embodiment of the present invention;

FIG. 27 is a sectional view showing a constitution of a light source device in accordance with an eleventh embodiment of the present invention;

FIG. 28 is a sectional view showing a constitution of a light source device in accordance with a twelfth embodiment of the present invention;

FIG. 29 is a sectional view showing a constitution of a light source device in accordance with a thirteenth embodiment of the present invention;

FIG. 30 is a sectional view showing a constitution of a light source device in accordance with a fourteenth embodiment of the present invention;

FIG. 31 is a sectional view showing a constitution of a light source device in accordance with a fifteenth embodiment of the present invention;

FIG. 32 is a sectional view showing another constitution of the light source device in accordance with the fifteenth embodiment of the present invention;

FIG. 33 is a sectional view explaining a manufacturing method of an optical element of the light source device of the present invention;

FIG. 34 is a sectional view explaining another example of the manufacturing method of the optical element of the light source device of the present invention;

FIG. 35 is a sectional view explaining a further example of the manufacturing method of the optical element of the light source device of the present invention;

FIG. 36 is a plan view showing a constitution of an image display device in accordance with an embodiment of the present invention; and

FIG. 37 is a plan view showing a constitution of an image display device in accordance with a second embodiment of the present invention.

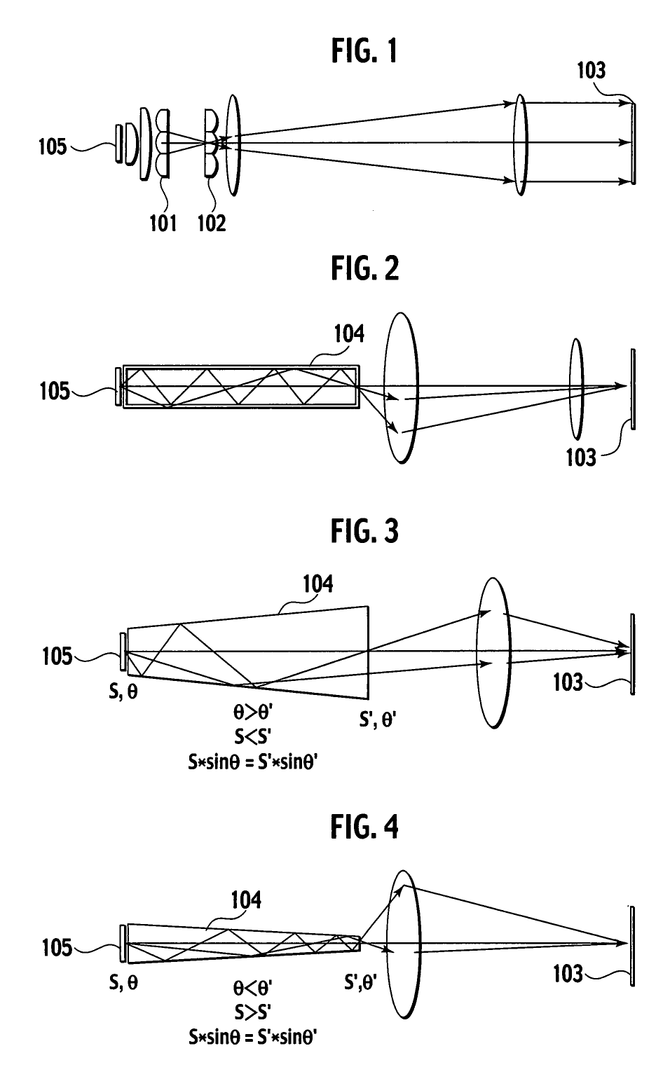

### DETAILED DESCRIPTION OF THE PREFERRED EMBODIMENTS

Constitutions of a light source device and an image display device employing the light source device in accordance with the present invention will be described with reference to various embodiments, in detail.

### 1^{st}. Embodiment of Light Source Device

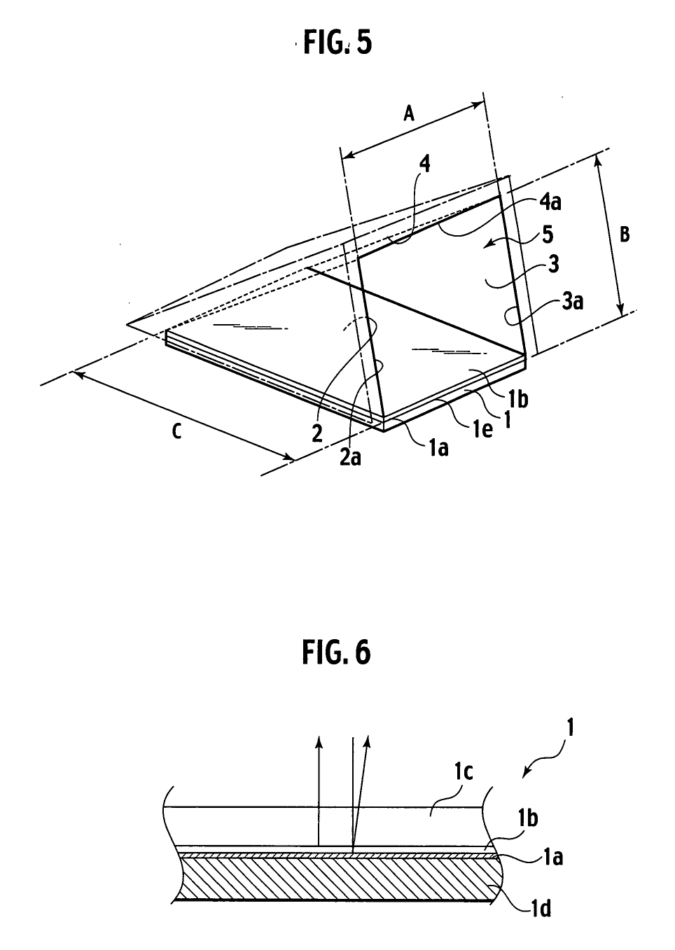

FIG. 5 is a perspective view showing the constitution of the light source device in accordance with the first embodiment of the present invention.

As shown in FIG. 5, the light source device has a solid light emitting element 1 forming a surface light emitting source. The solid light emitting element 1 has a reflection film 1a arranged on a back side of the element 1 and a light emitting layer (light emitting surface) 1b arranged on the front side. There exists so-called “high-luminance LED” available for this solid light emitting element 1.

FIG. 6 is a sectional view showing the constitution of the solid light emitting element in the light source device of the present invention.

In the high-luminance LED, as shown in FIG. 6, the reflection film 1a is formed on the back side of the light emitting layer 1b made of so-called the “photonics” crystal. Light is emitted from the light emitting layer 1b to both sides thereof (i.e. front and back sides of the layer 1b). The light emitted from the light emitting layer 1b to its front side is emitted toward the front side of the high-luminance LED. On the other hand, the light emitted from the same layer 1b to the back side is reflected by the reflection film 1a, subsequently transmitted through the light emitting layer 1b and finally emitted to the front side of the high-luminance LED. Incident light entering into the light emitting layer 1b is transmitted through the light emitting layer 1b and reflected by the reflection layer 1a. Then, the so-reflected light is transmitted through the light emitting layer 1b again and emitted to the front side of the high-luminance LED through the light emitting layer 1b. In this way, the high-luminance LED can effect high luminance performance because of the above reflecting of light component (optical element) used to be absorbed in the conventional LED.

Note that the light emitting layer 1b of this LED is formed so as to transmit light having a wavelength produced by the same layer 1b and therefore, incident light within the same waveband for the LED are transmitted through the light emitting layer 1b and further reflected by the reflection layer 1a on the back side of the layer 1b.

Note that the light emitting layer (light emitting surface) 1b of the solid light emitting element 1 is shaped to be rectangular, for example, a rectangle of 2 mm×6 mm.

As for materials of the light emitting layer 1b for such LED, there are available AlGaAs, AlGaInP, GaAsP, etc. for red LED, InGaN, AlGaInP, etc. for green LED and InGaN etc. for blue LED. In general, these InGaN-type materials are produced due to epitaxial growth on a sapphire substrate 1c. While, the reflection film 1a is produced by exfoliating semiconductor from the sapphire substrate 1c by laser lift-off technique and successively flattening its P-type semiconductor surface. For example, the reflection film 1a can be formed by applying direct-spattering on a back surface of the semiconductor. Note that the so-formed LED is arranged on a silicon substrate 1d while positioning the reflection film 1a on the lower side of LED and further supplied with power by not-shown wire bonding.

As shown in FIG. 5, this light source device has a first reflection surface 2 and a second reflection surface 3 opposing each other in parallel. These reflection surfaces 2, 3 are substantially perpendicularly to a surface (top surface) of the solid light emitting element 1. The first and second reflection surfaces 2, 3 are formed by mirrors each of which has a reflection film formed on a substrate (mirror base). In case of a reflection film of Al, the film has a reflectivity of approx. 92%. In case of a reflection film of Ag, the film has a reflectivity of approx. 98%.

Further, the light source device has a third reflection surface 4 substantially perpendicular to the first and second reflection surfaces 2, 3 Again, the third reflection surface 4 is opposed to the top surface of the solid light emitting element 1 obliquely. The third reflection surface 4 is also formed by a mirror similar to the first and second reflection surfaces 2, 3.

In the light source device, the reflection film 1a of the solid light emitting element 1 and the first to third reflection surfaces 2, 3, 4 constitute a closed polyhedron. This polyhedron has a rectangular emission opening 5 outlined by: one side edge 4a of the third reflection surface (upper surface) 4, which is far from the surface of the solid light emitting element 1; respective side edges 2a, 3a of the first and second reflection surfaces (side surfaces) 2, 3; and one side edge 1e of the reflection surface 1a of the solid light emitting element 1. The emission opening 5 has an area smaller than that of the light emitting surface 1b of the solid light emitting element 1.

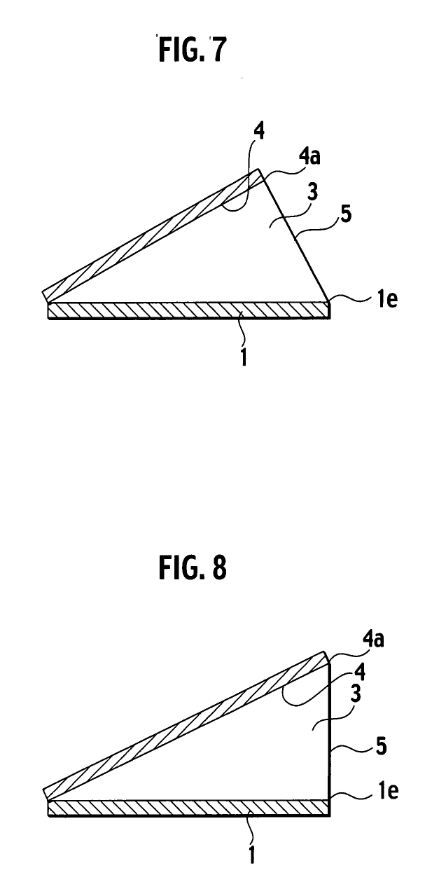

FIG. 7 is a sectional view showing one constitution of the light source device in accordance with the first embodiment of the present invention.

FIG. 8 is a sectional view showing another constitution of the light source device in accordance with the first embodiment of the present invention.

As shown in FIG. 7, preferably, the emission opening 5 is formed so as to be substantially perpendicular to the third reflection surface 4. However, the emission opening 5 may be formed so as not to be perpendicular to the third reflection surface 4, as shown in FIG. 8. In connection, although the light emitting surface 1b of the solid light emitting element 1 and the emission opening 5 are together shaped to be rectangular in this embodiment, the configuration of these elements may be modified to another form (e.g. circular, oval, etc.)

Note that each of FIGS. 7, 8 and FIGS. 10 to 16 (described later) does not illustrate both of the reflection surfaces 2, 3 but shows one of them (i.e. the second reflection surface 3) because of their longitudinal sectional views.

In this embodiment, as shown in FIG. 5, one side edge 1e of the reflection film 1a of the solid light emitting element 1, which constitutes a part of edges of the emission opening 5, coincides with one short side of the light emitting surface 1b of the element 1. Therefore, the emission opening 5 has two opposing sides (i.e. the side edge 1e of the reflection film 1a and the side edge 4a of the third reflection surface 4) whose each length is equal to a length of the short side of the light emitting surface of the solid light emitting element 1, as shown with arrow A of FIG. 5 and two other sides (i.e. the side edge 2a of the first reflection surface 2 and the side edge 3a of the second reflection surface 3) whose each length (shown with arrow B) is smaller than a long side (shown with arrow C) of the light emitting surface of the solid light emitting element 1.

The above-constructed light source device operates as follows. First, light emitted from the solid light emitting element 1 is reflected (or unreflected) by any of the first to third reflection surfaces 2, 3, 4 and the reflection film 1a of the solid light emitting element 1 and subsequently, the same light is emitted to the outside via the emission opening 5.

It is desirable that the interior of a polyhedron formed by the reflection film 1a of the element 1 and the first to third reflection surfaces 2, 3, 4 is filled up with a medium (e.g. air) having a refraction index equal to or smaller than that of an exterior medium (e.g. air) where the light emitted from the emission opening 5 travels. Then, there is no generation of reduced illumination efficiency caused by reflection of light at the emission opening.

In the conventional light source device using a rod integrator, meanwhile, if making an area of the emission opening for illumination light smaller than an emission area of a light source, the reflective angle of light rays becomes smaller at a boundary face with a propagation of the light rays in the rod, so that part of light rays couldn't be emitted from the emission opening as a result that the reflective angle becomes smaller than an all-reflective critical angle at the boundary face. On the contrary, according to the present invention, the light source device is formed so as to emit the light of the solid light emitting element 1 from the emission opening 5 at the smallest number of reflecting times as possible and additionally, light rays that couldn't be emitted from the emission opening are returned to the solid light emitting element 1 and further reflected by the reflection film 1a of the element 1. Accordingly, the light source device of the present invention is capable of emitting light from the emission opening 5 with high efficiency.

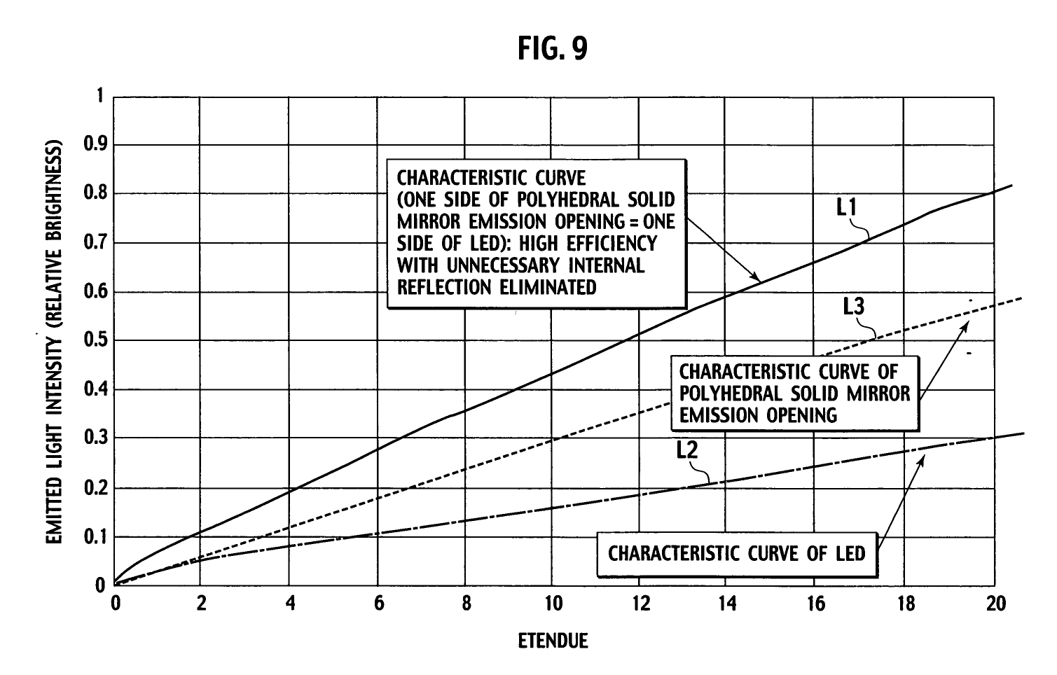

FIG. 9 is a graph showing a relationship between etendue and illuminating intensity in the light source device of the present invention.

According to the light source device of the invention, it will be understood that an intensity of emission light (relative luminance) in the characteristic curve of etendue (i.e. etendue curve: shown with a solid line L1) is higher than that of at a characteristic curve L2 (shown with an alternate long and short line) in the solid light emitting element 1 in itself at the same etendue.

As mentioned previously, the etendue is represented by Spsin²θ, where “S” is an emission area, “θ” is the irradiation angle of light rays. The characteristics curve of etendue represents an intensity of emission light (relative luminance: vertical axis) that would be obtained if setting the etendue (horizontal axis) to a predetermined value, in other words, the emission area “S” and the irradiation angle “θ” have predetermined values respectively: Note that the emission area “S” designates an area of the emission opening 5 in the light source device, while the emission area “S” designates an area of the light emitting surface 1b in the solid light emitting element 1 per se.

Note that a characteristic curve 13 shown with a dashed line of FIG. 9 denotes the characteristic curve of etendue in a light source device for comparison. In the comparative light source device, the first and second reflection surfaces 2, 3 are arranged so as not to be in parallel with each other and additionally, the side edge 1e of the reflection film 1a of the solid light emitting element has a different length from that of the side edge 4a of the third reflection surface 4. Comparing with the light source device of the present invention, as this comparative light source device has the increased number of internal reflections in a polyhedron formed by the reflection film 1a of the solid light emitting element 1 and the first to third reflection surfaces 2, 3, 4, the amount of light emitted from the light source device gets low corresponding to the reflectivity of the respective reflection surfaces. That is, as the light source device of the present invention has the first and second reflection surfaces 2, 3 paralleled with each other, the number of reflections of light in the polyhedron of the reflection film 1a of the solid light emitting element 1 and the first to third reflection surfaces 2, 3, 4, until the light is emitted from the emission opening 5 is small. Additionally, as the light source device of the present invention is formed in a manner that the reflection light returns to the solid light emitting element 1 with difficulty, it is possible to emit luminous rays with high efficiency.

It is also possible to converge the light from the solid light emitting element to the emission opening, allowing the utilization efficiency of illumination light and its luminance dominative for the light-source etendue to be improved.

Additionally, the emission distribution of the light source is also uniformized in the light source device. Therefore, even if tiny solid light emitting elements in place of a large solid light emitting element are adopted as the light source, it is possible to uniformize the emission distribution of these elements at their boundary surfaces.

According to this embodiment, since the light emitting surface of the solid light emitting element and the emission opening are together shaped to be rectangular, it is possible to illuminate a rectangular object to be illuminated (e.g. spatial light modulating element in an image display device) with high efficiency.

### 2nd. Embodiment of Light Source Device

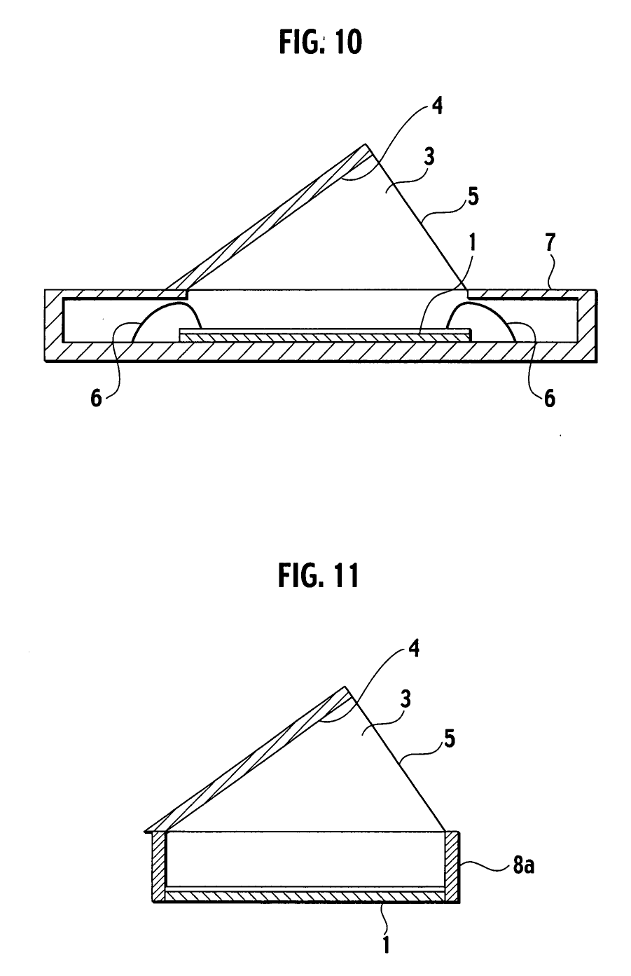

FIG. 10 is a sectional view showing a constitution of the light source device in accordance with the second embodiment of the present invention.

In the light source device of the invention, as shown in FIG. 10, the first to third reflection surfaces 2, 3, 4 may be arranged so as to avoid wires 6, 6 bonded to the solid light emitting element 1. In detail, according to this light source device of this embodiment, the solid light emitting element 1 is accommodated in a package 7 for covering the wires 6, 6 and further, the reflection surfaces 2, 3, 4 are arranged on the package 7. That is, a closed polyhedron is formed by the package 7 and the respective reflection surfaces 2, 3, 4 in spite of their arrangement to avoid the wires 6, 6.

In this embodiment also, the light emitted from the solid light emitting element 1 is emitted to the outside through the emission opening 5 after being reflected (or unreflected) by any of the first to third reflection surfaces 2, 3, 4 and the reflection film 1a of the solid light emitting element 1.

### 3^{rd}. Embodiment of Light Source Device

FIG. 11 is a sectional view showing a constitution of the light source device in accordance with the third embodiment of the present invention.

The light source device may be formed so as to interpose a light pipe 8a between the solid light emitting element 1 and the respective reflection surfaces 2, 3, 4, as shown in FIG. 11. The light pipe 8a is formed by a tubular hollow member having a rectangular section and also provided with four inner walls all forming respective reflection surfaces.

The respective reflection surfaces 2, 3, 4 are, arranged on an end surface of the light pipe 8a. These reflection surfaces 2, 3, 4 and the light pipe 8a constitute a closed polyhedron. Owing to the interposition of the light pipe 8a, it is possible to prevent the third reflection surface 4 from interfering with possible bonded wires (not shown) for the solid light emitting element 1.

In this embodiment also, the light emitted from the solid light emitting element 1 is emitted to the outside through the emission opening 5 after being reflected (or unreflected directly) by any one of the first to third reflection surfaces 2, 3, 4, the reflection film 1a of the solid light emitting element 1 and the inner walls of the light pipe 8a.

### 4^{th}. Embodiment of Light Source Device

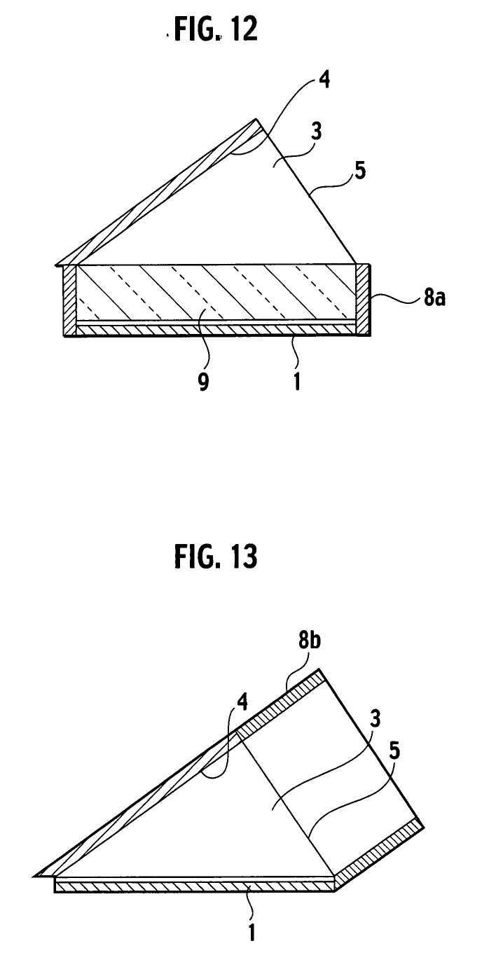

FIG. 12 is a sectional view showing a constitution of the light source device in accordance with the fourth embodiment of the present invention.

The light source device may be formed so as to have a transparent member 9 in the light pipe 8a interposed between the solid light emitting element 1 and the respective reflection surfaces 2, 3, 4, as shown in FIG. 12. For example, the transparent member 9 is made from a transparent flat plate. Owing to the arrangement of the transparent member 9, it is possible to prevent the third reflection surface 4 from interfering with possible bonded wires (not shown) for the solid light emitting element 1.

The respective reflection surfaces 2, 3, 4 are arranged on the transparent member 9. These reflection surfaces 2, 3, 4, the reflection film 1a and an inner surface of the transparent member 9 constitute a closed polyhedron.

In this embodiment also, the light emitted from the solid light emitting element 1 is emitted to the outside through the emission opening 5 after being reflected by any one of the first to third reflection surfaces 2, 3, 4, the reflection film 1a of the solid light emitting element 1 and the inner surface of the transparent member 9 or directly without such reflection.

### 5^{th}. Embodiment of Light Source Device

FIG. 13 is a sectional view showing a constitution of the light source device in accordance with the fifth embodiment of the present invention.

The light source device may be formed so as to have a light pipe 8b (or a rod integrator) extending from the emission opening 5, as shown in FIG. 13. The light pipe 8b is formed by a tubular hollow member having a rectangular section and also provided with four inner walls all forming respective reflection surfaces. These reflection surfaces 2, 3, 4, the reflection film 1a and the light pipe 8b constitute a closed polyhedron.

In this embodiment also, the light emitted from the solid light emitting element 1 is emitted to the outside through the end surface of the light pipe 8b after being reflected by any one of the first to third reflection surfaces 2, 3, 4, the reflection film 1a of the solid light emitting element 1 and respective inner walls of the light pipe 8b or directly without such reflection.

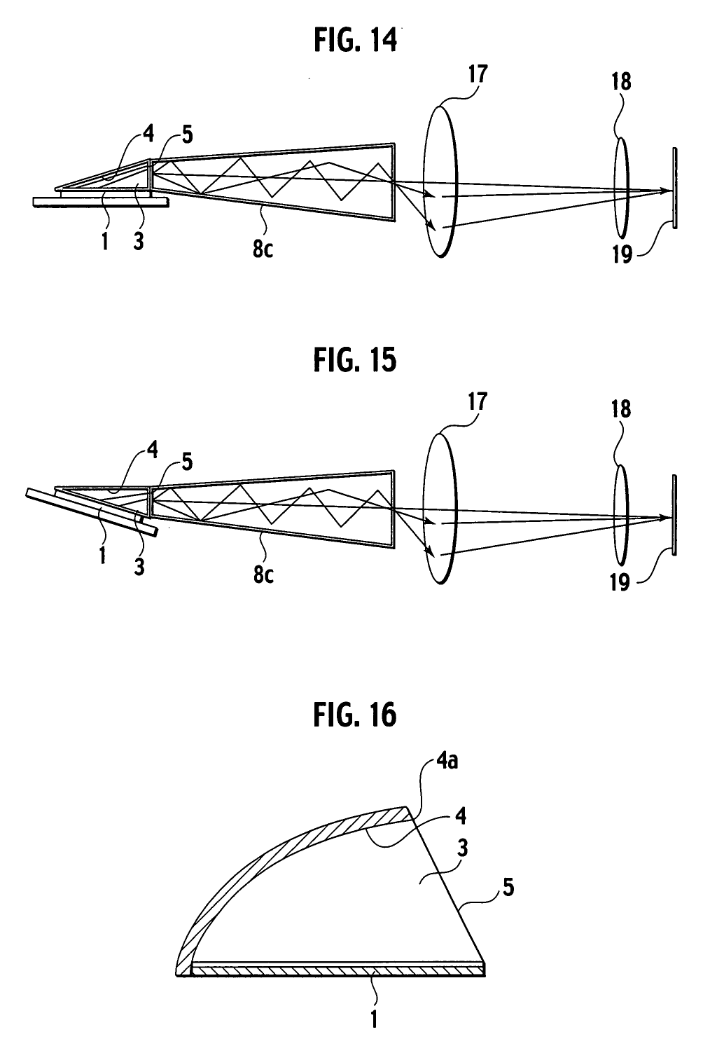

FIG. 14 is a sectional view showing another constitution of the light source device in accordance with the fifth embodiment of the present invention.

FIG. 15 is a sectional view showing a further constitution of the light source device in accordance with the fifth embodiment of the present invention.

The light source device may be formed so as to have a tapered light pipe 8c extending from the emission opening 5, as shown in FIGS. 14 and 15. Although the light pipe 8c is shaped to have a diameter gradually increased in the traveling direction of light rays in common with FIGS. 14 and 15, the light source device may be provided with a light pipe whose diameter is gradually reduced in the traveling direction of light rays, instead.

In both cases, according to this embodiment, it is possible to converge the light from the solid light emitting element 1 to the emission opening 5, allowing the utilization efficiency of illumination light to be improved. In addition, it is possible to introduce the light reaching the emission opening 5 into the light pipe 8c effectively, allowing a luminance of the illumination light dominative for the light-source etendue to be improved.

Additionally, the emission distribution of the light source is also uniformized in the light source device. Therefore, even if tiny solid light emitting elements in place of a large solid light emitting element are adopted as the light source, it is possible to uniformize the emission distribution of these elements at their boundary surfaces.

Note that light emitted from the so-formed light pipe 8c illuminates an object to be illuminated, for example, a spatial light modulating element 19 through the intermediary of field lenses 17, 18.

### 6^{th}. Embodiment of Light Source Device

FIG. 16 is a sectional view showing a constitution of the light source device in accordance with the sixth embodiment of the present invention.

The light source device may be formed so that the third reflection surface 4 is curved to be a concave surface facing the solid light emitting element 1, as shown in FIG. 16. In this case, the third reflection surface 4 may be identical to a curved surface, for example, a cylindrical surface that is shaped straightly in a parallel direction to the side edge 4a of the reflection surface (third reflection surface) 4 forming the emission opening 5 partially. Alternatively, the third reflection surface 4 may be formed by a spherical surface, a paraboloid or a higher-order curved surface. In this case also, the respective reflection surfaces 2, 3, 4 and the reflection surface 1a constitute a closed polyhedron.

In this embodiment also, the light emitted from the solid light emitting element 1 is emitted to the outside through the emission opening 5 after being reflected by any one of the first to third reflection surfaces 2, 3, 4, and the reflection film 1a of the solid light emitting element 1 or directly without such reflection.

Thus, since the third reflection surface 4 is curved, it is possible to improve the utilization efficiency of illumination light and its luminance dominative for the light-source etendue.

In the arrangement where the third reflection surface 3 is curve-shaped, additionally, the light source device may be provided with either the above-mentioned light pipe 8a interposed between the solid light emitting element 1 and the reflection surfaces 2, 3, 4 or the above-mentioned light pipe 8b extending from the emission opening 5.

### 7^{th}. Embodiment of Light Source Device

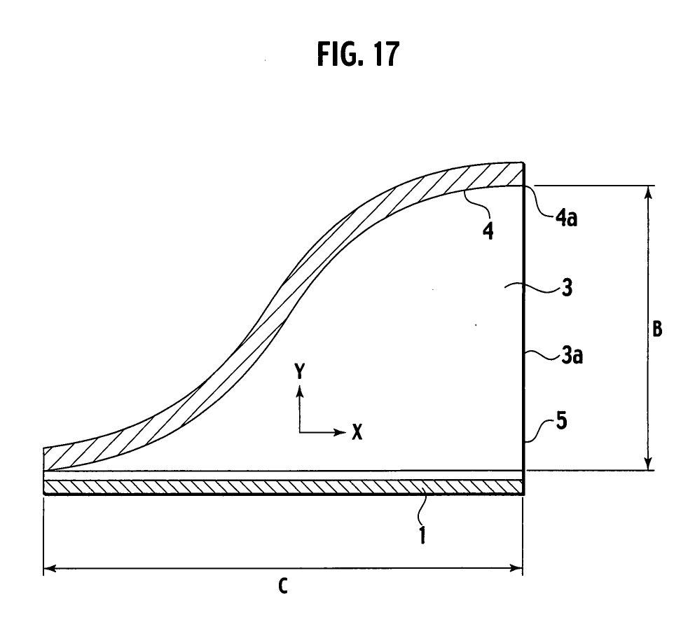

FIG. 17 is a sectional view showing a constitution of the light source device in accordance with the seventh embodiment of the present invention.

The light source device may be formed so as to optimize the shape of the third reflection surface 4 in order to maximize the utilization efficiency of light. For this purpose, as shown in FIG. 7, the third reflection surface 4 comprises a concave cylindrical surface (part) shaped to be concave to the solid light emitting surface 1 on a close side to the emission opening 5, an inflection point arranged at an intermediate point of the surface 4 and a convex cylindrical surface shaped to be convex to the solid light emitting surface 1 on a far side from the emission opening 5. In this case, the third reflection surface 4 comprises a curved surface, for example, a cylindrical surface that is shaped straightly in a parallel direction to the side edge 4a of the reflection surface (third reflection surface) 4 forming the emission opening 5 partially.

If the emission opening 5 has an area equal to 25% of the area of the solid light emitting element 1 and the solid light emitting element 1 has a reflectivity equal to 60% of the reflectivity of the reflection film 1a, the optimized shape of the third reflection surface 4 is represented by

Y=B*sin^{1.25}(X p/4C).

Here, “B” denotes a height of the solid light emitting element 1 from the emission opening 5, that is, each length of two sides (i.e. the side edges 2a, 3a of the first and second reflection surfaces 2, 3) shown with arrow B of FIG. 17. In FIG. 17, “C” denotes a length of the long side of the light emitting surface of the solid light emitting element 1. Additionally, “X” represents a distance from one side of the solid light emitting element 1 far from the emission opening 5, while “Y” represents a height from the solid light emitting element 1 to the third reflection surface 4 at “X”.

The inflection point in this curve coincides with a center of the third reflection surface 4 (X=C/2). This curve gets closer to a straight line as the reflectivity of the reflection film 1a of the solid light emitting element 1 gets higher.

Thus, according to the embodiment, owing to the above-mentioned configuration of the third reflection surface 4, it is possible to improve the utilization efficiency of illumination light and its luminance dominative for the light-source etendue.

### 8^{th}. Embodiment of Light Source Devices

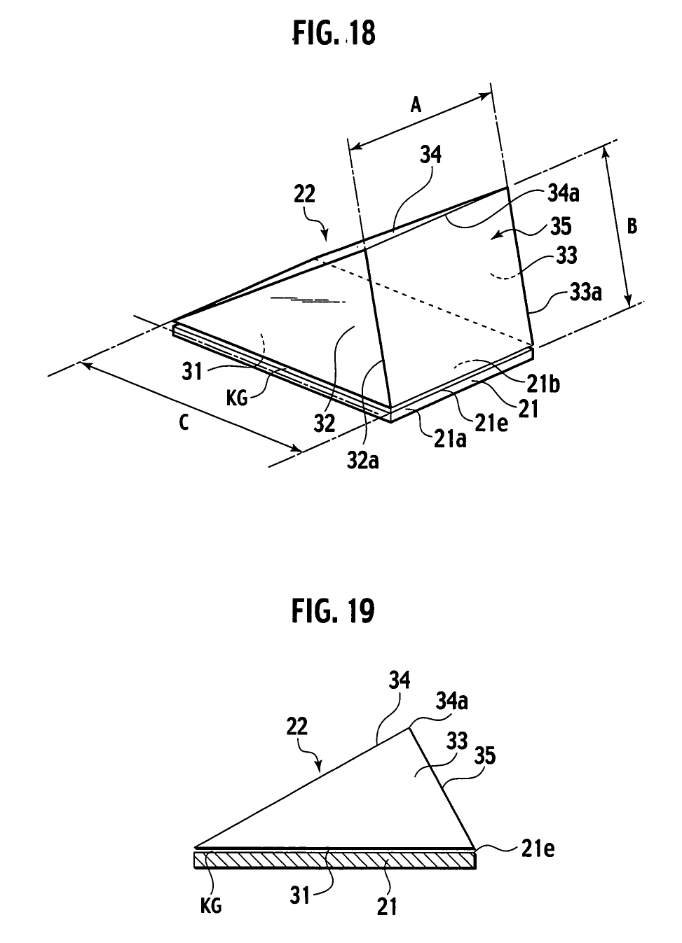

FIG. 18 is a perspective view showing a constitution of the light source device in accordance with the eighth embodiment of the present invention.

FIG. 19 is a longitudinal sectional view showing another constitution of the light source device in accordance with the eighth embodiment of the present invention.

As shown in FIGS. 18 and 19, the light source device has a solid light emitting element 21 forming a surface light emitting source. The solid light emitting element 21 has a reflection film 21a arranged on a back side of the element 21 and a light emitting layer (light emitting surface) 21b arranged on the front side. There exists so-called “high-luminance LED” available for this solid light emitting element 21.

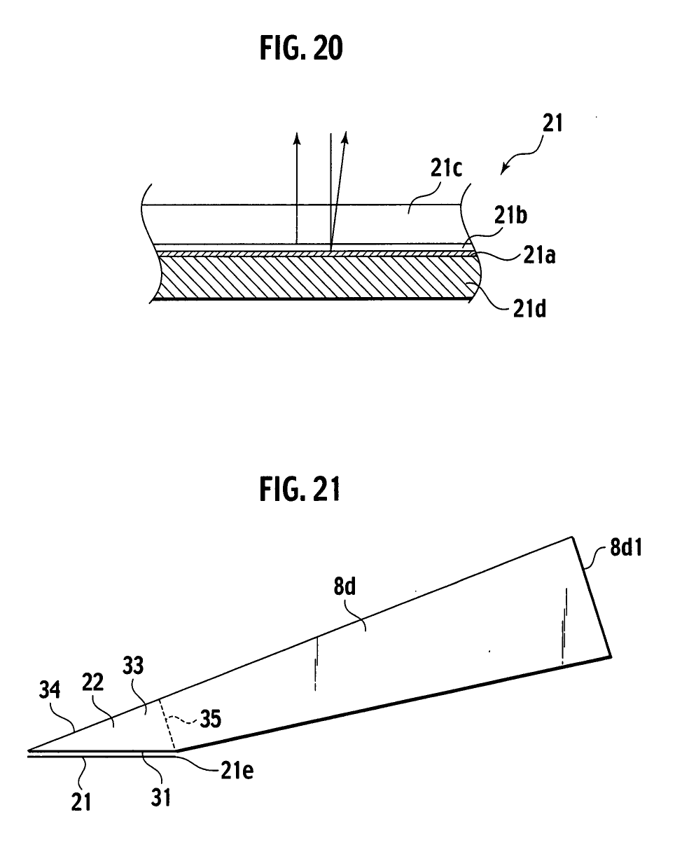

FIG. 20 is a sectional view showing the constitution of the solid light emitting element in the light source device of the present invention.

In the high-luminance LED, as shown in FIG. 20, the reflection film 21a is formed on the back side of the light emitting layer 21b made of so-called the “photonics” crystal. Light is emitted from the light emitting layer 21b to both sides thereof (i.e. front and back sides of the layer 21b). The light emitted from the light emitting layer 21b to its front side is emitted toward the front side of the high-luminance LED. On the other hand, the light emitted from the same layer 21b to the back side is reflected by the reflection film 21a, subsequently transmitted through the light emitting layer 21b and finally emitted to the front side of the high-luminance LED. Incident light entering into the light emitting layer 21b is transmitted through the light emitting layer 21b and reflected by the reflection layer 21a. Then, the so-reflected light is transmitted through the light emitting layer 21b again and emitted to the front side of the high-luminance LED through the light emitting layer 21b. In this way, the high-luminance LED can effect high luminance performance because of the above reflecting of light component (optical element) used to be absorbed in the conventional LED (on its back side).

Note that the light emitting layer 21b of this LED is formed so as to transmit light having a wavelength produced by the same layer 21b and therefore, incident lights within the same waveband for the LED are transmitted through the light emitting layer 21b and further reflected by the reflection layer 21a on the back side of the layer 21b.

Note that the light emitting layer (light emitting surface) 21b of the solid light emitting element 21 is shaped to be rectangular, for example, a rectangle of 2 mm×6 mm.

As for materials of the light emitting layer 21b for such LED, there are available AlGaAs, AlGaInP, GaAsP, etc. for red LED, InGaN, AlGaInP, etc. for green LED and InGaN etc. for blue LED. In general, these InGaN-type materials are produced due to epitaxial growth on a sapphire substrate 21c. While, the reflection film 21a is produced by exfoliating semiconductor from the sapphire substrate 21c by laser lift-off technique and successively flattening its P-type semiconductor surface. For example, the reflection film 21a can be formed by applying direct-spattering on a back surface of the semiconductor. Note that the so-formed LED is arranged on a silicon substrate 21d while positioning the reflection film 21a on the lower side of LED and further supplied with power by not-shown wire bonding.

As shown in FIGS. 18 and 19, this light source device has an optical element (prism) 22 having a first surface (bottom surface) 21 opposing the light emitting layer (light emitting surface) 21b of the solid light emitting element 21 through a gap KG. The first surface 31 of the optical element 22 is shaped so as to be substantially identical to the light emitting surface 21b of the solid light emitting element 21. The optical element 22 has second and third surfaces (side surfaces) 32, 33 formed to be substantially perpendicular to the first surface 31 and also paralleled with each other.

The optical element 22 further has a fourth surface 34 formed to be substantially perpendicular to the second and third surfaces 32, 33 and inclined to the first surface 31 while opposing it. Additionally, the optical element 22 has a fifth surface 35 whose margin is formed by respective side edges of the first to fourth surfaces 31, 32, 33 and 34.

That is, a space surrounded by the first to fifth surfaces 31, 32, 33, 34 and 35 is in the form of a triangle pole having bottom surfaces of the second and third surfaces 32, 33. In the optical element 22, the fifth surface 35 has an area smaller than an area of the first surface 31 (i.e. area of the light emitting surface 21b of the solid light emitting element 21).

Thus, according to the embodiment, it is possible to converge the light from the solid light emitting element 21 to the fifth surface 35, allowing the utilization efficiency of illumination light and its luminance dominative for the light-source etendue to be improved.

Additionally, the emission distribution of the light source is also uniformized in this light source device. Therefore, even if tiny solid light emitting elements in place of a large solid light emitting element are adopted as the light source, it is possible to uniformize the emission distribution of these elements at their boundary surfaces.

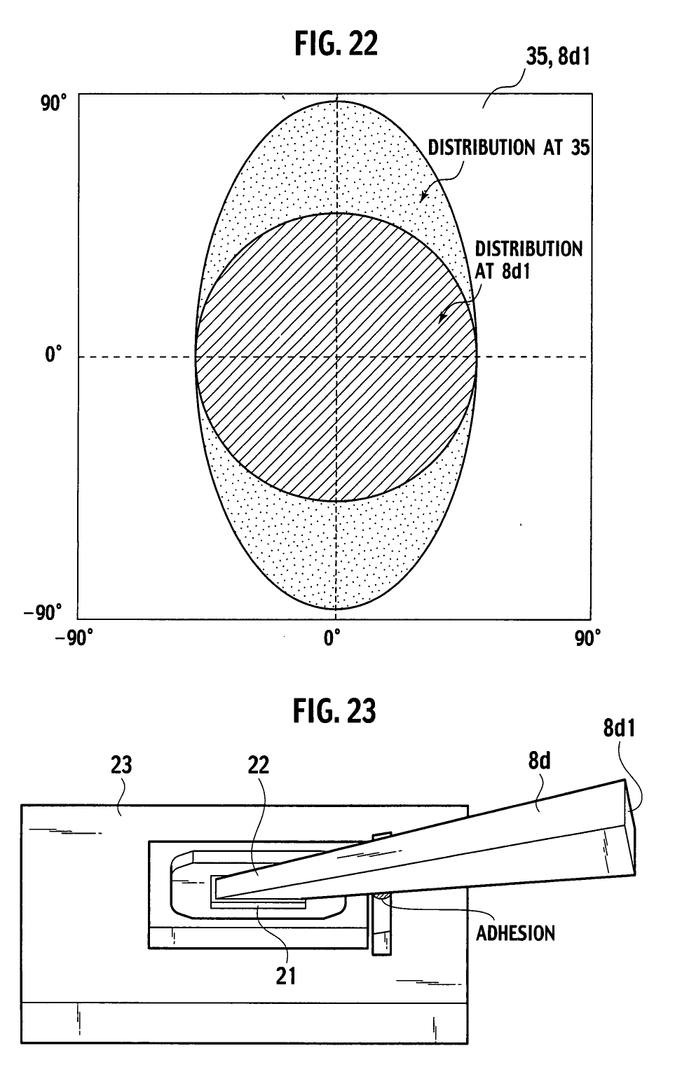

Note that each of FIG. 19 and FIGS. 21, 24, 25, 26, 27, 28, 30, 31, 32, 33, 34 and 35 (described later) does not illustrate both of the second and third surfaces 32, 33 but shows one of them (i.e. the third surface 33) because of their longitudinal sectional views.

In this embodiment, as shown in FIG. 18, one side edge 21e of the reflection film 21a of the solid light emitting element 21, which constitutes a part of edges of the fifth surface 5, coincides with one short side of the light emitting surface 21b of the element 21. Therefore, the fifth surface 35 has two opposing sides (i.e. the side edge 21e of the reflection film 21a and the side edge 34a of the fourth surface 34) whose each length is equal to a length of the short side of the light emitting surface of the solid light emitting element 21, as shown with arrow A of FIG. 18 and two other sides (i.e. the side edge 32a of the second surface 32 and the side edge 33a of the third surface 33) whose each length (shown with arrow B) is smaller than a long side (shown with arrow C) of the light emitting surface of the solid light emitting element 21.

A polyhedral space surrounded by the first to fifth surfaces 31, 32, 33, 34 and 35, that is, the interior of the optical element 22 is filled up with a medium (e.g. air) having a refraction index equal to or smaller than that of a surrounding medium (e.g. air). As the medium forming the optical element 22, for example, there are available cycloolefin polymer, such as “ZEONEX (trade mark of Nippon Zeon Co. Ltd.”, various optical synthetic materials, various optical glass materials and so on.

In the light source device, light generated from the solid light emitting element 21 enters the optical element 22 through the first surface 31 and is further emitted to the outside via the fifth surface 35 after being internally reflected by any of the first to fourth surfaces 31, 32, 43, 34 and the reflection film 21a of the solid light emitting element 21 (total reflection) or unreflected by these surfaces 31, 32, 33, 34 and the film 21a. Inside the optical element 22, if given that θ represents an incident angle of light lays against a certain surface in the element 22, “n” represents a refractive index of a medium outside the optical element 22 and “n′” represents a refractive index of a medium inside the optical element 22, then a condition for accomplishing the total reflection on the same surface can be expressed as

sin θ=n/n′.

Assuming that the medium outside the optical element 22 is air of 1 in the refractive index “n” while the medium inside the element 22 is “BK-1” of 1.51 in the refractive index “n′”, then the incident angle θ becomes approx. 41°. Thus, it means that all the light rays whose each incident angle against a certain surface is more than approx. 41° are subjected to total reflection.

In the light source device, therefore, as there exist light rays subjected to total reflection on the first surface 31 in spite of a low reflectivity of the reflection film 21a of the solid light emitting element 21, it is possible to lead the light rays inside the optical element 22 to the fifth surface 35 effectively.

In the light source device, it is desirable that the fourth surface 34 of the optical element 22 is formed with a reflection surface made from reflecting material or a reflecting part having a fine structure of photonic crystal. Then, owing to the formation of the reflection surface (or the reflecting part), it is possible to prevent light in the optical element 22 from being emitted to the outside through the fourth surface 34, allowing the utilization efficiency of light from the solid light emitting element 21 to be improved.

As for the reflecting material, there is available Al (aluminum)-film, Ag (argentums)-film, dielectric-film or the like. If Al-film as the reflecting film is formed on the fourth surface 34 of the element 22, then the reflectivity of the same surface 34 becomes approx. 92%. If Ag-film as the reflecting film is formed on the fourth surface 34 of the element 22, then the reflectivity of the same surface 34 becomes approx. 98%. In case of adopting either a dielectric-film or a reflecting part having the fine structure of photonic crystal, there is reflected, on the dielectric-film or the reflecting part, a specific monochromatic light (including lights having a half bandwidth of several dozen nm: e.g. light-emitting diode light), for example, only one of R (red light), G (green light) and B (blue light).

As for the characteristic curve of etendue in the light source device, an emission light intensity (relative luminance) is higher than that of at a characteristic curve in the solid light emitting element 1 in itself at the same etendue.

As mentioned previously, the etendue is represented by Spsin²θ, where “S” is an emission area, “θ” is the irradiation angle of light rays. The characteristics curve of etendue represents an intensity of emission light (relative luminance: vertical axis) that would be obtained if setting the etendue (horizontal axis) to a predetermined value, in other words, the emission area S and the irradiation angle θ have predetermined values respectively.

Note that the emission area S designates an area of the fifth surface 35 in the light source device, while the emission area S designates an area of the light emitting surface 21b in the solid light emitting element 21 per se.

Additionally, as the light source device of the present invention has the second and third surfaces 32, 33 paralleled with each other, it is small in the number of reflections that a light ray is subjected in the polyhedron formed by the reflection film 21a and the respective reflecting surfaces 32, 33 and 34 until it is emitted out of the fifth surface 35. Further, as the light source device is formed so as to return the reflected light returns to the solid light emitting element 21 with difficulty, it is possible to emit light rays effectively.

FIG. 21 is a longitudinal sectional view showing the constitution of the light source device of the eighth embodiment, which further includes a light pipe.

Regarding the above-mentioned light source device of the eighth embodiment, it should be noted that internal reflection may be caused at the fifth surface 35 since the medium in the optical element 22 has a refractive index larger than that of the surrounding medium. That is, all of light fluxes existing in the same element 22 are not always emitted to the outside. For this reason, as shown in FIG. 21, it is desirable that the light source device is provided with a light pipe 8d. In arrangement, the light pipe 8d is attached to the fifth surface 35 and formed integrally with the optical element 22. Further, the light pipe 8d is taper-shaped so that its sectional area increases gradually as departing from the optical element 22.

The light pipe 8d is made from a medium having a refractive index larger that that of the medium in the optical element 22, for example, optical synthetic resin and optical glass. The light pipe 8d has a leading surface (emission end face) 8d1 formed in parallel with the fifth surface 35. Suppose, the refractive index of the medium forming the light pipe 8d is equal to that of the medium forming the optical element 22, in other words, the medium forming the light pipe 8d is identical to the medium forming the optical element 22. Then, the fifth surface 35 becomes a nonexistent element. In this case, however, an imaginary surface passing through the side edge 21e of the reflection film 21a of the solid light emitting element 21 and also paralleled with the emission end face 8d1 of the light pipe 8d corresponds to the fifth surface 35. The fifth surface 35 (imaginary surface) has an area smaller than the area of the light emitting surface 21b of the solid light emitting element 21, as mentioned before.

In the above-constructed light source device, the light emitted from the solid light emitting element 21 enters into the optical element 21 through the first surface 31. Subsequently, the light further enters into the light pipe 8 through its base end after being repeatedly subjected to multiple reflections by any one of the first to fourth reflection surfaces 31, 32, 33, 34 and the reflection film 21a or directly without such reflection. Upon repeating internal reflection in the light pipe 8d, the light is emitted from the emission end face 8d1 to the outside with its improved corn-angle (incident angle) distribution. The light emitted from the emission end face 8d1 of the light pipe 8d in this way illuminates an object to be illuminated (e.g. spatial light modulating element) through the intermediary of field lenses (not shown).

FIG. 22 is a front view showing the corn-angle distribution at both the fifth surface 35 and the emission end face 8d1 of the light pipe 8d of the light source device in accordance with the eight embodiment of the present invention.

In the light source device of the eighth embodiment, as shown in FIG. 22, the corn-angle (incident angle) distribution of incident light at the fifth surface 25 ranges from 0° up to 90°. If the light source device is provided with no light pipe (8d), light rays each of which has an incident angle exceeding approx. 41° cannot be emitted from the fifth surface 35. According to the embodiment, however, owing to the provision of the light pipe 8d, all of light rays reaching the fifth surface 35 can enter into the light pipe 8d. Consequently, as shown in FIG. 22, the light rays are all improved so that the corn-angle distribution falls within approx. 41° at the emission end face 8d1 of the light pipe 8d. Thus, at the emission end face 8d1 of the light pipe 8d, almost all the light rays are emitted from the emission end face 8d1 to the outside.

The shape of the light pipe 8d depends on a corn-angle distribution at improvement. For instance, if it is desired to change a light having a corn-angle distribution ranging 90° to the same having a corn-angle distribution within 30°, then there is established the following relationship between “S” and “S′”:

S′=S*{sin(90°)/sin(30°)}²=4S

where “S” is an area of the incident surface of the light pipe 8d, and S′ is an area of the emission end face 8d1.

This expression is directed to improvements of the corn-angle distribution in both vertical and horizontal directions at the similar rate. While, in case of improving the corn-angle distribution in one direction (vertical direction or horizontal direction), there is established a following relationship between “X” and “X′”:

X′=X{sin(90°)/sin(30°)}=2X

where “X” is a length of one side of the incident surface of the light pipe 8d in the vertical direction or the horizontal direction, and “X′” is a length of one side of the emission end face 8d1 (i.e. one side corresponding to the above side of the incident surface).

The length of the light pipe 8d may be optionally determined as occasion demands since it is related with an improvement ratio of the corn-angle distribution. Note that the light pipe 8d is formed with a length within the range from 1.5 cm to 3 cm in this embodiment.

In the arrangement where the light pipe 8d is formed integrally with the optical element 22, additionally, the light pipe 8d may be provided, on its surface succeeding to the fourth surface 34 of the optical element 22, with a reflection surface of reflection material as well as the fourth surface 34. Then, owing to the formation of the reflecting surface, it is possible to prevent light in the optical element 22 from being emitted to the outside through the fourth surface 34, allowing the utilization efficiency of light from the solid light emitting element 21 to be improved.

FIG. 23 is a perspective view showing the constitution of the light source device in accordance with the eighth embodiment of the present invention.

As for such a light source device that the light pipe 8d is formed integrally with the optical element 22, the formation of this device can be accomplished by adhesively fixing an intermediate portion of the light pipe 8d, which is formed integrally with the optical element 22, onto a package 23 having the built-in solid light emitting element 21 while allowing the optical element 22 to oppose the solid light emitting element 21, as shown in FIG. 23.

As for adhesives for this purpose, if adopting ZEONEX (trade mark of Nippon Zeon Co. Ltd.) for the optical element 22 and the light pipe 8d, there are recommended “XNR5552” (products name: UV-curable type acrylic adhesive, made by Nagase ChemteX Corporation) and “XVL90K” (products name: UV-curable type acrylic adhesive, made by Kyoritsu Chemical & Co., Ltd.). Further, if adopting optical glass for the optical element 22 and the light pipe 8d, there are recommended “ELC2500Clear” (products name: UV-heat and curable type epoxy adhesive, made by Electro-Life Corporation), “XNR5541” (products name: UV-heat and curable type epoxy adhesive, made by Nagase ChemteX Corporation), “U-1541” (products name: UV-curable type epoxy adhesive, made by Chemitech Co., Ltd.), etc.

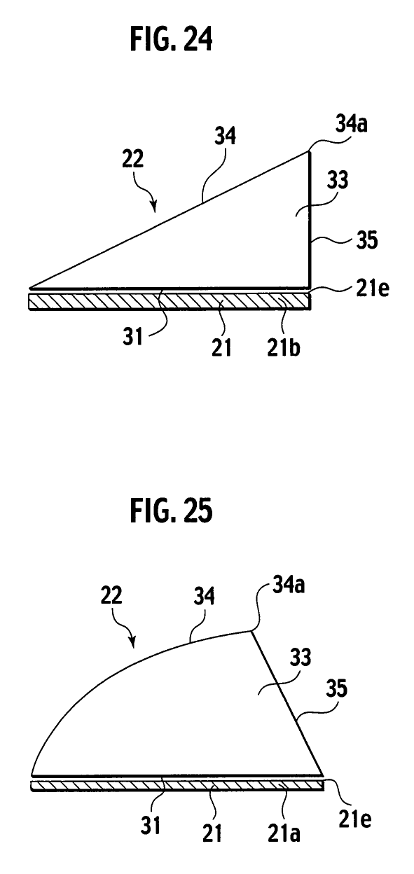

FIG. 24 is a sectional view of another constitution of the light source device of the eighth embodiment of the present invention.

In the light source device, it is preferable that the fifth surface 35 of the optical element 22 is formed to be substantially perpendicular to the fourth surface 34, as shown in FIG. 19. However, the fifth surface 35 may be formed so as not to be perpendicular to the fourth surface 34, as shown in FIG. 24. Additionally, although the solid light emitting element 21 of this embodiment has the light emitting surface 21b and the fifth surface 35 both shaped to be rectangular, respective configurations of these surfaces 21b, 35 are not limited to the shown embodiments.

In the conventional light source device using a rod integrator, meanwhile, if making an area of the light emitting surface for illumination light smaller than an emission area of a light source, the reflective angle of light rays becomes smaller at a boundary face with a propagation of the light rays in the rod, so that part of light rays couldn't be emitted from the light emitting surface as a result that the reflective angle becomes smaller than an all-reflective critical angle at the boundary face. On the contrary, according to the present invention, the light source device is formed so as to allow the light of the solid light emitting element 21 to pass through the fifth surface 35 at the smallest number of reflecting times as possible. Accordingly, the light source device of the present invention is capable of emitting light from the emission end face 8d1 with high efficiency.

### 9^{th}. Embodiment of Light Source Device

FIG. 25 is a sectional view showing the constitution of the light source device in accordance with the ninth embodiment of the present invention. Note that FIG. 25 does not illustrate both of the second and third surfaces 32, 33 but shows one of them (i.e. the third surface 33) because of its longitudinal sectional view.

According to the ninth embodiment, as shown in FIG. 25, the fourth surface 34 is curved to be a concave surface facing the solid light emitting element 21. In this case, the fourth surface 34 may be identical to a curved surface, for example, a cylindrical surface that is shaped straightly in a parallel direction to the side edge 34a of this reflection surface (fourth surface) 34 forming the fifth surface 35 partially. Alternatively, the fourth surface 34 may be formed by a spherical surface, a paraboloid or a higher-order curved surface.

In this case also, the respective reflection surfaces 31, 32, 33, 34 and 35 constitute a closed polyhedron.

In this embodiment also, the light emitted from the solid light emitting element 21 is emitted to the outside through the fifth surface 35 after being reflected by any one of the first to fourth surfaces 31, 32, 33, 34 and the reflection film 21a of the solid light emitting element 21 or unreflected by these reflective elements.

In the arrangement where the fourth surface 34 is curve-shaped, additionally, preferably, the light source device is provided with the above-mentioned light pipe 8d formed integrally with the fifth surface 35.

### 10^{th}. Embodiment of Light Source Device

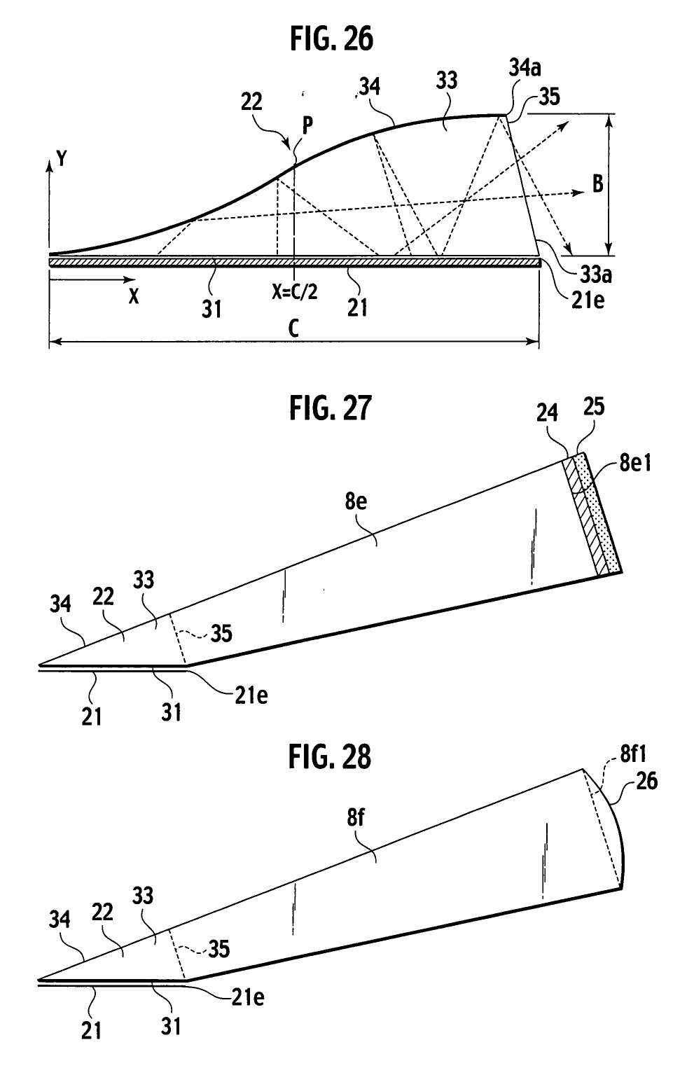

FIG. 26 is a sectional view showing the constitution of the light source device in accordance with the tenth embodiment of the present invention.

According to the tenth embodiment, the shape of the fourth surface 34 is optimized so as to maximize the utilization efficiency of light.

In detail, as shown in FIG. 26, the fourth surface 34 is shaped so as to have a concave-and-cylindrical surface (part) facing the first surface 31 on its near side to the fifth surface 35 and a convex-and-cylindrical surface (part) on the far side from the fifth surface 35 while interposing an inflexion point P therebetween. In this case, the fourth surface 34 comprises a curved surface, for example, a cylindrical surface that is shaped straightly in a parallel direction to the side edge 34a of the reflection surface (fourth surface) 34 forming the fifth surface 35 partially.

If the fifth surface 35 has an area equal to 25% of the area of the solid light emitting element 21 and the solid light emitting element 21 has a reflectivity equal to 60% of the reflectivity of the reflection film 21a, the optimized shape of the fourth surface 34 is represented by

Y=B*sin^{1.25}(X p/4C).

Here, “B” denotes a height of the solid light emitting element 21 from the fifth surface 35, that is, each length of two sides (i.e. the side edges 32a, 33a of the second and third surfaces 32, 33) shown with arrow B of FIG. 26. In FIG. 26, “C” denotes a length of the long side of the light emitting surface of the solid light emitting element 21. Additionally, “X” represents a distance from one side of the solid light emitting element 21 far from the fifth surface 35, while “Y” represents a height from the solid light emitting element 21 to the fourth surface 34 at “X”.

The inflection point P in this curve coincides with a center of the fourth surface 34 (X=C/2). This curve gets closer to a straight line as the reflectivity of the reflection film 21a of the solid light emitting element 21 gets higher.

### 11^{th}. Embodiment of Light Source Device

FIG. 27 is a sectional view showing the constitution of the light source device in accordance with the eleventh embodiment of the present invention.

According to the eleventh embodiment of the invention, a light pipe 8e is provided, on its emission end face 8e1, with a quarter-wave (λ/4) plate 24 and a reflecting deflection plate (wire grid) 25.

In operation, some of light components reaching the emission end face 8e1 are transmitted through the quarter-wave plate 24 and the reflecting deflection plate 25 and further emitted to the outside. While, the other light components whose deflecting directions preclude a possibility of transmission of light through the reflecting deflection plate 25 are reflected by the reflecting deflection plate 25 and successively returned into the light pipe 8e through the quarter-wave plate 24. Then, the so-returned light components are reflected inside the light pipe 8e and the optical element 22 and further transmitted to the reflecting deflection plate 25 through the quarter-wave plate 24 again. At that time, certain light components whose deflecting directions have been converted so as to be transmissible through the reflecting deflection plate 25 are emitted to the outside via the same plate 25.

Repetitions of the above-mentioned process allow the illumination light (light components) having deflecting directions aligned with each other to be emitted from the emission end face 8e1 with high efficiency. This feature (i.e. high-efficiency gain of illumination light whose deflecting directions are aligned with each other) is advantageous in illuminating a spatial light modulating element for deflective modulation.

### 12^{th}. Embodiment of Light Source Device

FIG. 28 is a sectional view showing the constitution of the light source device in accordance with the twelfth embodiment of the present invention.

According to the embodiment, as shown in FIG. 28, a light pipe 8f is provided, on its emission end face 8f1, with a lens (convex lens or concave lens) 26 integrally.

In operation, the light reaching the emission end face 8f1 is emitted on convergence or diffusion of the lens 26. As the lens 26 is formed on the emission end face 8f1 of the light pipe 8f integrally, the so-constructed light source device of this embodiment has an advantage of reducing the number of components, particularly in case of illuminating an object to be illuminated with the use of light that has been emitted the light pipe 8f and successively conducted by a specific lens, such as field lens.

### 13^{th}. Embodiment of Light Source Device

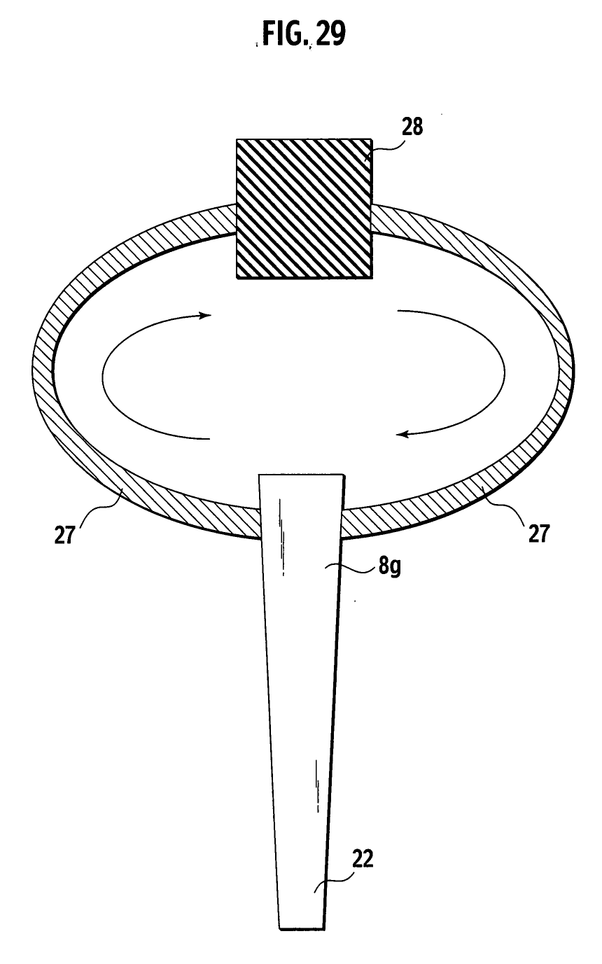

FIG. 29 is a plan view showing the constitution of the light source device in accordance with the thirteenth embodiment of the present invention.

According to the thirteenth embodiment of the invention, the optical element 22 is formed to be a hollow body. Alternatively, both of the optical element 22 and a light pipe 8g are together formed so as to have hollow bodies. Further, the optical element 22 (or the same plus the light pipe 8g) is filled up with liquid of a predetermined refractive index. In detail, the optical element 22 and the light pipe 8g have respective external parts made from thin transparent materials, forming hollow transparent bodies respectively. As for the liquid supplied into the optical element 22 and the light pipe 8g, there may be adopted water, organic material (e.g. diethyl ether) or the like.

In operation, the liquid filling in the optical element 22 and the light pipe 8g is circulated between these elements and a heat exchanger 28 through a circulating pipe 27, as shown in FIG. 29. In detail, the liquid in the optical element 22 and the light pipe 8g is heated due to heat generate from the solid light emitting element 21 and fed to the heat exchanger 28 through the circulating pipe 27. At the heat exchanger 28, the liquid is cooled down and subsequently returned into the optical element 22 and the light pipe 8g through the circulating pipe 27.

In the light source device constructed above, due to repetitions of this circulation of the heat medium, it is possible to suppress a rising in temperature of the liquid in the optical element 22 and the light pipe 8g.

As for the liquid for the optical element 22 and the light pipe 8a, it is desirable to adopt liquid exhibiting high transmissivity and high cooling performance. Additionally, it is desirable that the optical element 22 and the light pipe 8a are respectively formed, on their respective inner surfaces, with reflection surfaces of reflecting material. As for the reflecting material, there is available Al (aluminum)-film, Ag (argentums)-film or the like. If adopting Al-film as the reflecting film, then the reflectivity becomes approx. 92%. If adopting Ag-film as the reflecting film, then the reflectivity becomes approx. 98%.

However, it should be noted that no reflection surface is formed on the first surface 31 of the optical element 22 with the necessity of receiving the light from the solid light emitting element 21. Additionally, with the necessity of letting in the light from the optical element 21, no reflection surface is formed on the fifth surface 35 because of its imaginary surface in the arrangement where the light pipe 8g is formed integrally with the optical element 21.

Suppose, this light source device has the optical element 22 made from a solid medium. Then, if five internal reflections occur in the optical element 22 under condition that the above medium has an optical absorption of 1%, the whole transmissivity amounts to the fifth power of 99%, i.e. approx 95%, so that the light of approx. 5% is absorbed in the medium. It means that if the power of incident light is 10 W, then the light of 0.5 W is absorbed. Suppose, the medium forming the optical element 22 has a mass of 0.025 g (4 mm×2.5 mm×1 mm, specific gravity: 2.5). Then, as a calorific value that the optical element 22 absorbs per second is equal to 0.5 J (=0.5 W×1 sec.), the temperature rise becomes as

(0.5×1)/(0.7×0.025)=6.7 [K].

That is, assuming that no heat is radiated out of the optical element 22, its temperature is elevated in increments of 6.7° C. per second. Therefore, when the optical element 22 is made from material of low heat conductivity, there is the possibility that the optical element 22 is heated highly to cause its fusion or breakage.

According to the embodiment, however, since the optical element 22 and the light pipe 8g are filled up with the liquid that is circulated in order to suppress the temperature rising in the optical element 22 and the light pipe 8g, it is possible to prevent such fusion or breakage of the optical element 22.

### 14^{th}. Embodiment of Light Source Device

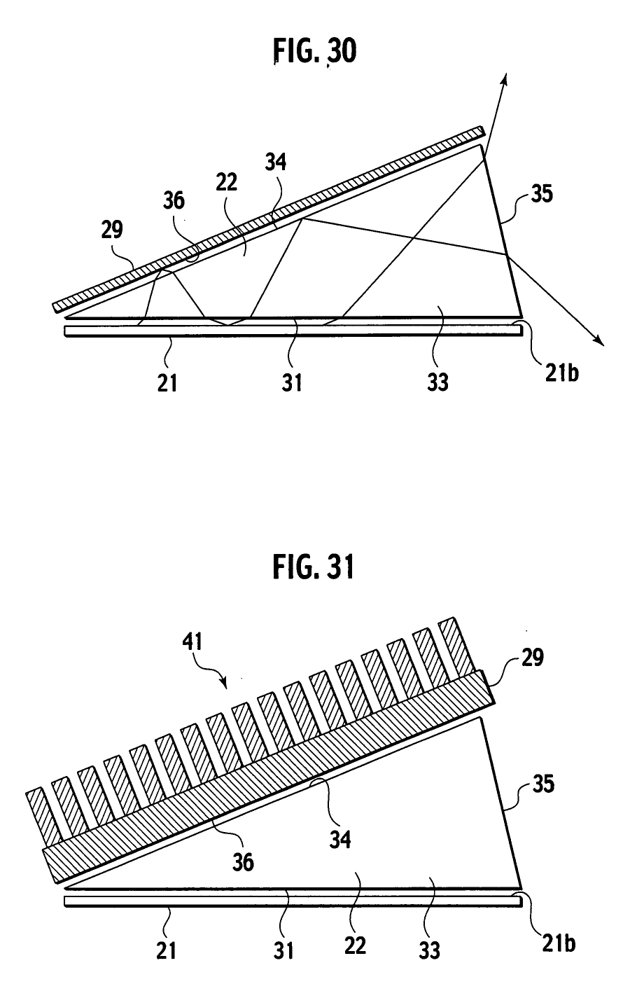

FIG. 30 is a sectional view showing the constitution of the light source device in accordance with the fourteenth embodiment of the present invention. Note that FIG. 30 does not illustrate both of the second and third surfaces 32, 33 but shows one of them (i.e. the third surface 33) because of its longitudinal sectional view.

According to the fourteenth embodiment of the present invention, a reflection surface is not formed on the fourth surface 34 of the optical element 22 in the constitution of the above-mentioned light source device. Instead, as shown in FIG. 30, a reflection surface 36 is arranged so as to be substantially parallel with the fourth surface 34. A small space between the reflection surface 36 and the fourth surface 34 is filled up with a medium having a refractive index smaller than that of the medium filling the optical element 22. The reflection surface 36 is formed, on its surface opposing the fourth surface 34, with an Al (aluminum)-film (reflectivity: 92%), an Ag (argentums)-film (reflectivity: 98%), a dielectric-film or a fine-structured reflecting part of photonic crystal. In this case, owing to the formation of the reflecting part, it is possible to prevent light in the optical element 22 from being emitted to the outside through the fourth surface 34, allowing the utilization efficiency of light from the solid light emitting element 21 to be improved. As mentioned before, the dielectric-film or the fine-structured reflecting part of photonic crystal is adapted so as to reflect a specific monochromatic light (including lights having a half bandwidth of several dozen nm: e.g. light-emitting diode light), for example, only one of “R” (red light), “G” (green light) and “B” (blue light).

Note that a carrier 29 for the reflection surface 36 is preferably formed by material allowing a formation of the reflection film and also having heat resistance, conduction or both properties of them. For instance, there are recommended glass materials (e.g. BK7, B270, etc.) and ceramics as the materials superior to heat resistance, and metals (e.g. Ag, Cu, Al) as the materials superior to conductivity. Alternatively, by grinding a surface of the carrier 36 made of metal, it is also possible to provide the reflection surface 36 that is superior to reflectivity, heat resistance and conductivity.

In the light source device, light transmitted through the fourth surface 34 without its total reflection is reflected by the reflection surface 36 and successively returned to the optical element 22. Most of light (rays) returned to the interior of the optical element 22 is further returned up to the solid light emitting element 21. Therefore, the light emitted from the solid light emitting element 21 is emitted to the outside through the fifth surface 35 after being reflected by any one of the first to fourth surfaces 31, 32, 33, 34, the reflection film 21a of the solid light emitting element 21 and the reflections surface 36 or directly without such reflection.

In the light source device, since the fourth surface 34 is provided with no reflecting material, it is possible to prevent the fourth surface 34 from being heated by incident light. If given that θ represents an incident angle of light lays against the first surface 31 of the optical element 22 or the fourth surface 34, n represents a refractive index of a medium outside the optical element 22 and n′ represents a refractive index of a medium inside the optical element 22, then a condition for accomplishing the total reflection on the same surface can be expressed as

sin θ=n/n′.

Assuming that the medium outside the optical element 22 is air of 1 in the refractive index “n” while the medium inside the element 22 is glass material “BK-1” of 1.51 in the refractive index “n′”, then the incident angle θ becomes approx. 41°.

Thus, it means that in the optical element 22, all the light rays whose each incident angle against the first surface 31 or the fourth surface 34 is more than approx. 41° are subjected to total reflection on the same surface. Therefore, as there exist light rays subjected to total reflection on the first surface 31 in spite of a low reflectivity of the reflection film 21a of the solid light emitting element 21, it is possible to collect the light rays to the fifth surface 35 effectively.

In the fourteenth embodiment also, it should be noted that internal reflection may be caused at the fifth surface 35 since the medium in the optical element 22 has a refractive index larger than that of the surrounding medium. That is, all of light fluxes existing in the same element 22 are not always emitted to the outside. For this reason, it is desirable that the light source device is provided with a light pipe that is connected, at the fifth surface 35, with the optical element 22 integrally and that is taper-shaped so that its sectional area increases gradually as departing from the optical element 22. This light pipe may be similar to each of the above-mentioned light pipes 8d, 8e, 8f and 8g, in terms of its configuration and structure.

In the fourteenth embodiment also, as similar to the above-mentioned embodiments, the fourth surface 34 may be identical to a curved surface, for example, a cylindrical surface that is shaped straightly in a parallel direction to the side edge 34a of the fourth surface 34 forming the fifth surface 35 partially. In this case, it is desirable that the reflection surface 36 is identical to a curved surface along the fourth surface 34.

### 15^{th}. Embodiment of Light Source Device

FIG. 31 is a sectional view showing the constitution of the light source device in accordance with the fifteenth embodiment of the present invention.

In connection with the light source device of the fourteenth embodiment of FIG. 30, according to the fifteenth embodiment, the carrier 39 for carrying the reflection surface 36 is provided, on its backside, with a cooling mechanism. In detail, as shown in FIG. 31, the carrier 29 is provided with a heat sink structure 41 corresponding to the cooling mechanism. The heat sink structure 41 is formed with a plurality of cooling fins implanted in the carrier 29. The heat sink structure 41 is made of material superior to conductivity, for example, Ag, Cu, Al, etc.

In the light source device constructed above, since heat produced on the reflection surface 36 due to incidence of light is radiated to the outside through the carrier 29 and the heat sink structure 41, it is possible to suppress an increase in temperature of the reflection surface 36.

Note that the carrier 29 for the reflection surface 36 is preferably formed by material allowing a formation of the reflection film and also having heat resistance, conduction or both properties of them. For instance, there are recommended glass materials (e.g. BK7, B270, etc.) and ceramics as the materials superior to heat resistance, and metals (e.g. Ag, Cu, Al) as the materials superior to conductivity. Alternatively, by grinding a surface of the carrier 36 made of metal, it is also possible to provide the reflection surface 36 that is superior to reflectivity, heat resistance and conductivity. When the carrier 29 is made of metal, the heat sink structure 41 can be formed integrally with the carrier 29 integrally.

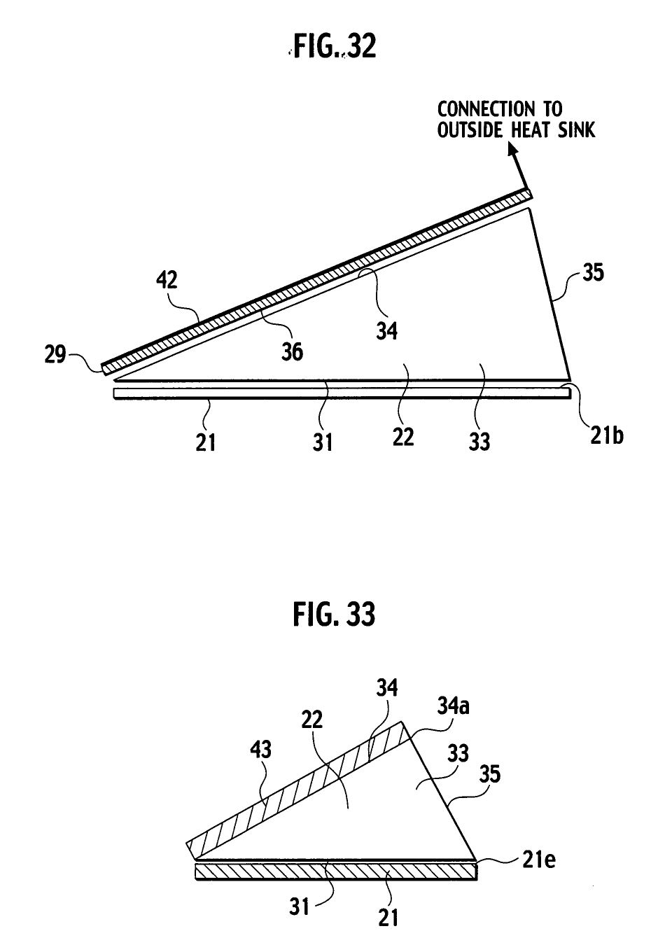

FIG. 32 is a sectional view showing another constitution of the light source device in accordance with the fifteenth embodiment of the present invention.

In this modification, no cooling mechanism is directly arranged on the carrier 29 carrying the reflection surface 36. Instead, a graphite sheet 42 is attached on a back surface of the carrier 29 so as to transfer heat of the carrier 29 to a not-shown cooling mechanism, such as heat sink, as shown FIG. 32. The graphite sheet 42 is made from graphite crystals, which is superior to heat conduction in a specific direction. The heat of the carrier 29 is transmitted to the cooling mechanism (heat sink etc.) through the graphite sheet 42 effectively.

In the light source device also, since heat produced on the reflection surface 36 due to incidence of light is radiated to the outside through the carrier 29, the graphite sheet 42 and the cooling mechanism, it is possible to suppress an increase in temperature of the reflection surface 36.

Suppose here, the reflecting material forming the reflection surface 36 has a reflectivity of 98% (i.e. optical absorption of 2%). Then, if five internal reflections occur on the reflection surface 36, the whole transmissivity amounts to the fifth power of 98%, i.e. approx 90%, so that the light of approx. 10% is absorbed in the reflecting material. It means that if the power of incident light is 1 W, then the light of 1 W is absorbed in the form of heat. Suppose, the medium forming the optical element 22 has a mass of 0.025 g (4 mm×2.5 mm×1 mm, specific gravity: 2.5) and a calorific value of the optical element 22 is 0.7 (J/gK). If the above heat is accumulated in the optical element 22, then the temperature rise per second becomes as

(1×1)/(0.7×0.025)=13.4 [K].

That is, assuming that no heat is radiated out of the optical element 22, its temperature is elevated in increments of 13.4° C. per second. In such a case, the optical element 22 is subjected to its deformation, breakage, fusion, etc. finally.

In the light source device, owing to a heat sink structure (not shown) provided on the carrier 29 for the reflection surface 36 or a cooling mechanism through the graphite sheet 42, heat generating on the reflection surface 36 is released to the outside. Further, since a gap between the reflection surface 36 and the optical element 22 is filled up with a medium of high heat insulation, such as air, it is possible to suppress thermal effect of the reflection surface 36 on the optical element 22 to the utmost.

In the fifteenth embodiment also, it should be noted that internal reflection may be caused at the fifth surface 35 since the medium in the optical element 22 has a refractive index larger than that of the surrounding medium. That is, all of light fluxes existing in the same element 22 are not always emitted to the outside. For this reason, it is desirable that the light source device is provided with a light pipe that is connected, at the fifth surface 35, with the optical element 22 integrally and that is taper-shaped so that its sectional area increases gradually as departing from the optical element 22. This light pipe may be similar to each of the above-mentioned light pipes 8d, 8e, 8f and 8g, in terms of its configuration and structure.

In the fifteenth embodiment also, as similar to the above-mentioned embodiments, the fourth surface 34 may be identical to a curved surface, for example, a cylindrical surface that is shaped straightly in a parallel direction to the side edge 34a of the fourth surface 34 forming the fifth surface 35 partially. In this case, it is desirable that the reflection surface 36 is identical to a curved surface along the fourth surface 34.

[Manufacturing Method of Optical Element]

In order to improve the illumination efficiency without increasing the quantity of emission light per unit area in the optical element 21 due to an improved etendue by improving the utilization efficiency of light from the element 21, it is necessary to maintain the configuration of the optical element 21 with high accuracy in the above-mentioned light source device. In particular, as the optical element 22 is easy to produce chips in an acute-angled edge between the first surface 31 and the fourth surface 34, it is difficult to handle the optical element 22 before and after processing.

FIG. 33 is a sectional view explaining the manufacturing method of the optical element in the light source device of the present invention.

In the light source device in common with the eighth to fifteenth embodiments of the invention, as shown in FIG. 33, a protecting member 43 is attached to the fourth surface 34 in order to protect the acute-angled edge between the first surface 31 and the fourth surface 34. This protecting member 43 is in the form of a flat plate made from materials identical or similar to the optical element 22. After forming a reflection surface on the fourth surface 34, the protecting member 43 is applied onto the reflection surface.

As adhesives for attaching the protecting member 43, there are available UV-curable type acrylic adhesive for synthetic resin, and UV-heat and curable type epoxy adhesive and UV-curable type epoxy adhesive for optical glass.

Alternatively, the protecting member 43 may be previously formed with a reflection surface in place of the reflection surface to be formed on the fourth surface 34. That is, the reflection surface can be realized by applying the protecting member 43 provided with a reflection surface to the fourth surface 34 provided with no protecting surface.

Further, when forming the optical element 22 of synthetic resin by injection molding, no processing sequential to the injection molding is applied on the first surface 31 and the fourth surface 24. In this case, therefore, the protecting member 43 is attached after completing to form the first surface 31 and the fourth surface 34.

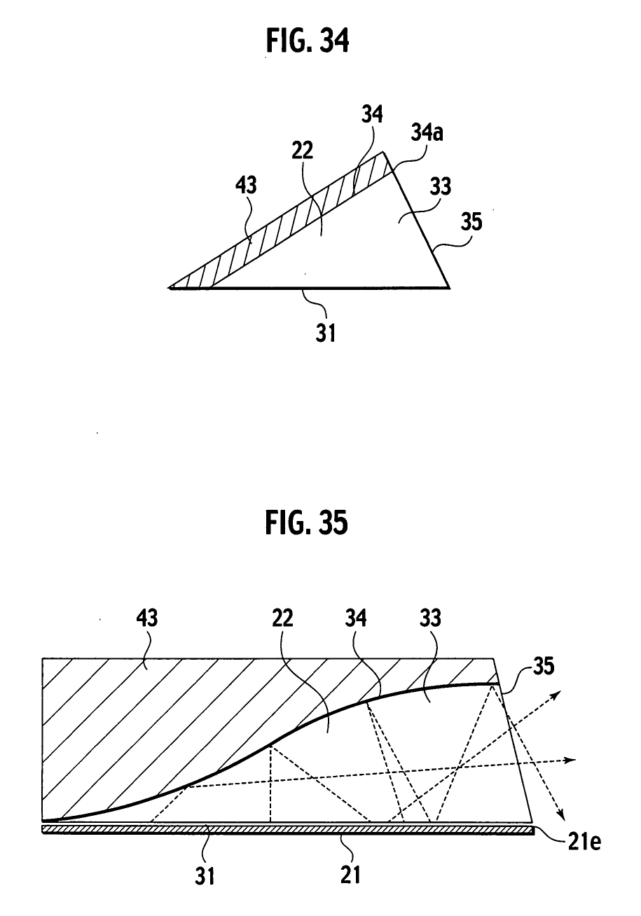

FIG. 34 is a sectional view explaining another example of the manufacturing method of the optical element in the light source device of the present invention.

While, in case of grinding an optical glass to form the optical element 22, as shown in FIG. 34, the first surface 31 may be provided by first attaching the protecting member 43 to the fourth surface 34 and successively grinding a margin of the protecting member 43 and the first surface 31 together.

Note, even when forming the optical element 22 of synthetic resin by injection molding, the first surface 31 may be provided by first attaching the protecting member 43 to the fourth surface 34 of the optical element 22 and further grinding the margin of the protecting member 43 and the first surface 31 together.

FIG. 35 is a sectional view explaining a further example of the manufacturing method of the optical element in the light source device of the present invention.

If the fourth surface 34 is formed by a curved surface, as shown in FIG. 35, it is first performed to produce a protecting member 43 having a profile following the shape of the fourth surface 34 and further attach the so-formed protecting member 43 onto the fourth surface 34 by adhesive.

For the optical element 22 having the fourth surface 34 curved, alternatively, the protecting member 43 may be formed by either UV-curable synthetic resinous material or heat-curable synthetic resinous material. In this case, the protecting member 43 could be finished by first putting the above resinous material in its unhardened state on the fourth surface 34 of the optical element 22 and subsequently hardening the resinous material.

As mentioned above, by applying the protecting member 43 onto the fourth surface 34 of the optical element 22, there can be provided beneficial effects as follows:

(1) By attaching the protecting member to the optical member, its handling can be accomplished to facilitate the assembling operation of the light source device.

(2) By adopting exoergic material (e.g. aluminum) as the protecting member, the polyhedron generating heat due to light absorption of the reflection film can be cooled down by heat radiation.

(3) By adopting exoergic material (e.g. graphite sheet) as the protecting member, the polyhedron generating heat due to light absorption of the reflection film can be cooled down by heat radiation.

(4) By performing vapor deposition of a reflection film on the protecting member, the productivity of vapor deposition can be improved.

By adopting the above manufacturing method, it is possible to prevent the acute-angled edge between the first surface 31 and the fourth surface 34 of the optical element 22 in the light source device from getting chipped, facilitating the handling of the optical element 22 before and after processing. Additionally, by maintaining the configuration of the optical element 22 with high accuracy and further improving the utilization efficiency of light emitted from the solid light emitting element 21 thereby improving its etendue, it is possible to improve the illumination efficiency without increasing the quantity of emission light per unit area in the optical element 21.

### 1^{st} Embodiment of Image Display Device

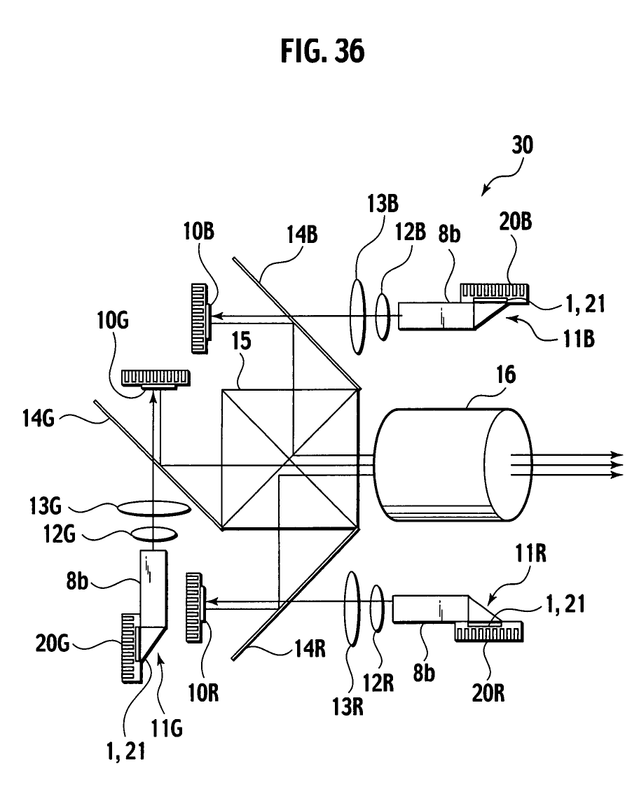

FIG. 36 is a plan view showing a constitution of an image display device 30 of the present invention.

As shown in FIG. 36, the image display device 30 comprises light source devices 11R, 11G and 11B mentioned above, spatial light modulating elements 10R, 10G and 10B illuminated by lights emitted from the light source devices 11R, 11G and 11B and an imaging optics system (e.g. a projection lens 16). The imaging optics system receives lights through the elements 10R, 10G and 10B and focuses into an image from images of the elements 10R, 10G and 10B.

That is, the image display device 30 is a unit that illuminates the spatial light modulating elements 10R, 10G and 10B by the corresponding light source devices 11R, 11G and 11B and produces a color image as a result of color combination of respective modulation lights via the light modulating elements 10R, 10G and 10B.

When the light source devices 11R, 11G and 11B employ reflecting parts having fine structures of photonic crystals, the reflecting part in the light source device 11R emitting red light is adapted so as to reflect the red light (R), the reflecting part in the light source device 11G emitting green light is adapted so as to reflect the green light (G), and the reflecting part in the light source device 11B emitting blue light is adapted so as to reflect the blue light (B).

The spatial light modulating elements 10R, 10G and 10B display red, green and blue components forming a display image (color image) respectively and modulate illumination lights corresponding to these images (components) in polarization. In this embodiment, the spatial light modulating elements 10R, 10G and 10B are type of reflection, each of which modulates incident illumination light on polarization modulation and lets the light through.

Each of the light source devices 11R, 11G and 11B includes the solid light emitting element, the first to third reflection surfaces and the rod integrator 8b extending from the emission opening, as mentioned above. In the light source devices 11R, 11G and 11B, the respective solid light emitting elements 1 (21) are arranged on the heat sinks 20R, 20G and 20B, respectively.

The light source device 11R illuminates the spatial light modulating element 10R for displaying an image of red component, with red illumination light. The light source device 11G illuminates the spatial light modulating element 10G for displaying an image of green component, with green illumination light. The light source device 11B illuminates the spatial light modulating element 10B for displaying an image of blue component, with blue illumination light.

The illumination light emitted from the light source device 11R for red is transmitted through a relay lens 12R, a field lens 13R and a wire grid 14R and enters the spatial light modulating element 10R. Then, the red illumination light is reflected by the reflective spatial light modulating element 10R that performs polarization modulation corresponding to an image signal of red component. The red illumination light as a red image light enters a color combining prism 15.

The illumination light emitted from the light source device 11B for blue is transmitted through a relay lens 12B, a field lens 13B and a wire grid 14B and enters the spatial light modulating element 10B. Then, the blue illumination light is reflected by the reflective spatial light modulating element 10B that performs polarization modulation corresponding to an image signal of blue component. The blue illumination light as a blue image light enters the color combining prism 15.

The illumination light emitted from the light source device 11G for green is transmitted through a relay lens 126, a field lens 13G and a wire grid 14G and enters the spatial light modulating element 10G. Then, the green illumination light is reflected by the reflective spatial light modulating element 10G that performs polarization modulation corresponding to an image signal of green component. The green illumination light as a green image light enters the color combining prism 15.

In the color combining prism 15, the red, green and blue image lights are combined in color and subsequently enter the projection lens 16 forming the imaging optics system. The projection lens 16 projects the image lights of respective colors on a not-shown screen and focuses into an image in enlargement, accomplishing the image display.

According to the above-mentioned embodiment, the image display device 30 is capable of illuminating the spatial light modulating elements 10R, 10G, 10B by the lights from the light source devices 11R, 11G, 11B with high efficiency, accomplishing the image displaying of high luminance.

### 2^{nd}. Embodiment of Image Display Device

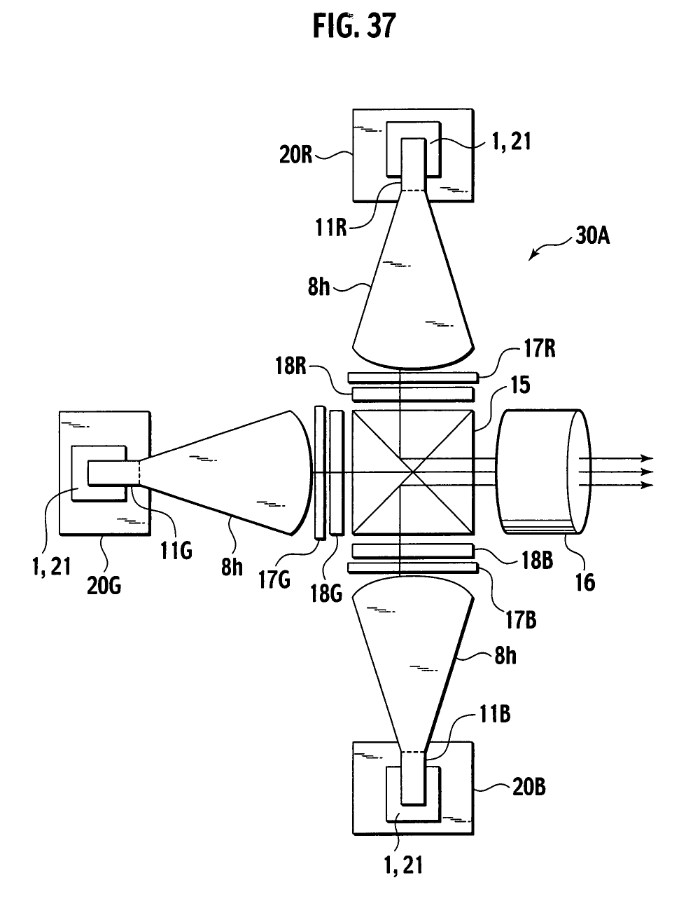

FIG. 37 is a plan view showing a constitution of an image display device in accordance with the second embodiment of the present invention.

According to the second embodiment, the image display device 30A is constructed to have transmissive spatial light modulating elements.

As shown in FIG. 37, the image display device 30A comprises the above-mentioned light source devices 11R, 11G and 11B, transmissive spatial light modulating elements 18R, 18G and 18B illuminated by lights emitted from the light source devices 11R, 11G and 11B and an imaging optics system 13. The imaging optics system 13 receives lights through the transmissive spatial light modulating elements 18R, 18G and 18B and focuses into an image from respective images of the elements 18R, 18G and 18B. That is, the image display device 30A is a unit that illuminates the transmissive spatial light modulating elements 18R, 18G and 18B by the corresponding light source devices 11R, 11G and 11B and produces a color image as a result of color combination of respective modulation lights via the light modulating elements 18R, 18G and 18B.

When the light source devices 11R, 11G and 11B employ reflecting parts having fine structures of photonic crystals, the reflecting part in the light source device 11R emitting red light is adapted so as to reflect the red light (R), the reflecting part in the light source device 11G emitting green light is adapted so as to reflect the green light (G), and the reflecting part in the light source device 11B emitting blue light is adapted so as to reflect the blue light (B).

The transmissive spatial light modulating elements 18R, 18G and 18B display red, green and blue components forming a display image (color image) respectively and modulate illumination lights corresponding to these images (components) in polarization. In this embodiment, the spatial light modulating elements 18R, 18G and 18B are type of transmission, each of which modulates incident illumination light on polarization and lets the light through.

Each of the light source devices 11R, 11G and 11B includes the solid light emitting element, the first to fifth reflection surfaces and a rod integrator 8h extending from the fifth surface, as mentioned above. The rod integrator 8h has an emission surface in the form of a lens having a convex curvature.

Note that this emission surface may be modified to a lens having a concave curvature or a flat surface in the course of optimizing its configuration to the size of the spatial light modulating element 18R (18G, 18B) and F-number of the imaging optics system. In the light source devices 11R, 11G and 11B, the respective solid light emitting elements 1 (21) are arranged on the heat sinks 20R, 20G and 20B, respectively.

The light source device 11R illuminates the transmissive spatial light modulating element 18R for displaying an image of red component, with red illumination light. The light source device 11G illuminates the transmissive spatial light modulating element 18G for displaying an image of green component, with green illumination light. The light source device 11B illuminates the transmissive spatial light modulating element 18B for displaying an image of blue component, with blue illumination light.

The illumination light emitted from the light source device 11R for red is transmitted through a deflection plate 17R for linear polarization and enters the transmissive spatial light modulating element 18R. Then, the red illumination light is reflected is further transmitted through the transmissive spatial light modulating element 18R that performs polarization modulation corresponding to an image signal of red component. The red illumination light as a red image light enters the color combining prism 15.

The illumination light emitted from the light source device 11B for blue is transmitted through a deflection plate 17B for linear polarization and enters the transmissive spatial light modulating element 18B. Then, the blue illumination light is further transmitted through the transmissive spatial light modulating element 18B that performs polarization modulation corresponding to an image signal of blue component. The blue illumination light as a blue image light enters the color combining prism 15.

The illumination light emitted from the light source device 11G for green is transmitted through a deflection plate 17G for linear polarization and enters the transmissive spatial light modulating element 18G. Then, the green illumination light is further transmitted through the transmissive spatial light modulating element 18G that performs polarization modulation corresponding to an image signal of green component. The green illumination light as a green image light enters the color combining prism 15.

In the color combining prism 15, the red, green and blue image lights are combined in color and subsequently enter the projection lens 16 forming the imaging optics system. The projection lens 16 projects the image lights of respective colors on a not-shown screen and focuses into an image in enlargement, accomplishing the image display.

Finally, it will be understood by those skilled in the art that the foregoing descriptions are nothing but embodiments and various modifications of the disclosed light source device, the image display device, the optical element and its manufacturing method and therefore, various changes and modifications may be made within the scope of claims.

What is claimed is:

1. A light source device comprising:
a solid light emitting element forming a surface emission light source having a reflection film arranged on a back side of the surface emission light source and a light emitting surface arranged on the front side of the surface emission light source;
first and second reflection surfaces formed to oppose each other in parallel, the first and second reflection surfaces being substantially perpendicular to a front surface of the solid light emitting element; and
a third reflection surface formed to oppose the front surface of the solid light emitting element, the third reflection surface being substantially perpendicular to the first and second reflection surfaces and inclined to the front surface of the solid light emitting element; wherein
the reflection film of the solid light emitting element, the first reflection surface, the second reflection surface and the third reflection surface constitute a closed polyhedron having an emission opening defined by a side edge of the third reflection surface on a far side of the front surface of the solid light emitting element, one side edge of the first reflection surface, one side edge of the second reflection surface and one side edge of the reflection film; and
the emission opening has an area smaller than an area of the light emitting surface of the solid light emitting element,
whereby light generated from the solid light emitting element is emitted to an outside through the emission opening after being either reflected by any one of the first to third reflection surfaces and the reflection film or unreflected by the first to third reflection surfaces and the reflection film.

2. The light source device of claim 1, wherein
the polyhedron formed by the reflection film and the first to third reflection surfaces is filled up with a medium having a refractive index equal to or smaller than a refractive index of an exterior medium where the light emitted from the emission opening travels.

3. The light source device of claim 1, wherein
the light emitting surface of the solid light emitting element and the emission opening are together rectangular.

4. The light source device of claim 1, wherein
the third reflection surface is a curved surface.

5. The light source device of any one of claim 1, wherein
the third reflection surface has a surface opposing the solid light emitting element, which comprises:
a concave cylindrical surface shaped to be concave to the solid light emitting element and positioned close to the emission opening;
an inflection point arranged at an intermediate point of the surface; and
a convex cylindrical surface shaped to be convex to the solid light emitting element and positioned apart from the emission opening.

6. An image display device comprising:
the light source device of claim 1;
a spatial light modulating element illuminated by light emitted from the light source device; and
an imaging optics that receives light transmitted through the spatial light modulating element thereby to produce an image of the spatial light modulating element.

7. A light source device comprising:
a solid light emitting element forming a surface emission light source having a reflection film arranged on a back side of the surface emission light source and a light emitting surface arranged on the front side of the surface emission light source; and
an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedral space surrounded by the first to fifth surfaces and filled up with a medium having a refractive index larger than a refractive index of an exterior medium surrounding the optical element; wherein
the fifth surface has an area smaller than an area of the light emitting surface of the solid light emitting element,
whereby light generated from the solid light emitting element enters into the optical element through the first surface and is emitted to an outside through the fifth surface after being either reflected by any one of the first to fourth surfaces and the reflection film or unreflected by the first to fourth surfaces and the reflection film.

8. A light source device comprising:
a solid light emitting element forming a surface emission light source having a reflection film arranged on a back side of the surface emission light source and a light emitting surface arranged on the front side of the surface emission light source;
an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedral space surrounded by the first to fifth surfaces and filled up with a medium having a refractive index larger than a refractive index of an exterior medium surrounding the optical element; and
a light pipe made from a medium having a refractive index larger than the refractive index of the medium in the optical element and successively formed integrally with the optical element at the fifth surface of the optical element, the light pipe having a configuration tapered so as to gradually increase its cross sectional area as departing from the optical element and having a leading surface formed in parallel with the fifth surface to provide an emission end face, wherein
the fifth surface has an area smaller than an area of the light emitting surface of the solid light emitting element,
whereby light generated from the solid light emitting element enters into the optical element through the first surface and successively enters into the light pipe through the fifth surface after being either reflected by any one of the first to fourth surfaces and the reflection film or unreflected by the first to fourth surfaces and the reflection film, and finally, the light is emitted to an outside through the emission end face of the light pipe.

9. The light source device of claim 8, wherein
the light pipe is provided, on the emission end face, with either a reflecting deflection plate or the reflecting deflection plate and a quarter-wave plate.

10. The light source device of claim 7, wherein
the fourth surface and a surface of the light pipe succeeding to the fourth surface are respectively formed with either a reflection surface made of a reflecting material or a reflection part having a fine structure of photonic crystals.

11. A light source device comprising:
a solid light emitting element forming a surface emission light source having a reflection film arranged on a back side of the surface emission light source and a light emitting surface arranged on the front side of the surface emission light source;
an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedral space surrounded by the first to fifth surfaces and filled up with a medium having a refractive index larger than a refractive index of an exterior medium surrounding the optical element; and
a reflection surface arranged to be substantially parallel with the fourth surface through a small space filled up with a medium having a refractive index smaller than the refractive index of the medium filling the optical element, wherein
a gap between a front surface of the solid light emitting element and the optical element is filled up with a medium having a refractive index smaller than the refractive index of the medium filling the optical element, and
the fifth surface of the optical element has an area smaller than an area of the light emitting surface of the solid light emitting element,
whereby light generated from the solid light emitting element enters into the optical element through the first surface and is emitted to an outside through the fifth surface after being either subjected to any one of a total reflection on the first to fourth surfaces, a reflection on the reflection film of the solid light emitting element and a reflection on the reflection surface, or unreflected by the first to fourth surfaces, the reflection film of the solid light emitting element and the reflection film.

12. A light source device comprising:
a solid light emitting element forming a surface emission light source having a reflection film arranged on a back side of the surface emission light source and a light emitting surface arranged on the front side of the surface emission light source;
an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedral space surrounded by the first to fifth surfaces and filled up with a medium having a refractive index larger than a refractive index of an exterior medium surrounding the optical element;
a reflection surface arranged to be substantially parallel with the fourth surface through a small space filled up with a medium having a refractive index smaller than the refractive index of the medium filling the optical element; and
a light pipe made from a medium having a refractive index larger than the refractive index of the medium in the optical element and successively formed integrally with the optical element at the fifth surface of the optical element, the light pipe having a configuration tapered so as to gradually increase its cross sectional area as departing from the optical element and having a leading surface formed in parallel with the fifth surface to provide an emission end face, wherein
a gap between a front surface of the solid light emitting element and the optical element is filled up with a medium having a refractive index smaller than the refractive index of the medium filling the optical element, and
the fifth surface of the optical element has an area smaller than an area of the light emitting surface of the solid light emitting element,
whereby light generated from the solid light emitting element enters into the optical element through the first surface and successively enters into the light pipe through the fifth surface after being either subjected to any one of a total reflection on the first to fourth surfaces, a reflection on the reflection film of the solid light emitting element and a reflection on the reflection surface, or unreflected by the first to fourth surfaces, the reflection film of the solid light emitting element and the reflection film, and finally, the light is emitted to an outside through the emission end face of the light pipe.

13. The light source device of claim 12, wherein
the light pipe is provided, on the emission end face, with either a reflecting deflection plate or a quarter-wave plate.

14. The light-source device of claim 11, further comprising:
a carrier supporting the reflection surface, the carrier being provided with a cooling mechanism.

15. The light source device of claim 7, wherein
the fourth surface is a curved surface.

16. The light source device of claim 7, wherein
the fourth surface has a surface opposing the solid light emitting element, which comprises:
a concave cylindrical surface shaped to be concave to the first surface and positioned close to the fifth surface;
an inflection point arranged at an intermediate point of the surface; and
a convex cylindrical surface shaped to be convex to the first surface and positioned apart from the fifth surface.

17. An image display device comprising:
the light source device of claim 7;
a spatial light modulating element illuminated by light emitted from the light source device; and
an imaging optics that receives light transmitted through the spatial light modulating element thereby to produce an image of the spatial light modulating element.

18. An optical element formed as a polyhedron having a plurality of surfaces and filled up with a solid medium, wherein
an acute-angled edge is formed between a first surface of the plurality of surfaces and a second surface opposed and inclined to the first surface, and
a protecting member is attached at least in the vicinity of the acute-angled edge of the second surface.

19. A light source device comprising:
a solid light emitting element forming a surface emission light source having a reflection film arranged on a back side of the surface emission light source and a light emitting surface arranged on the front side of the surface emission light source; and
an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedral space surrounded by the first to fifth surfaces and filled up with a medium having a refractive index larger than a refractive index of an exterior medium surrounding the optical element, the optical element having a protecting member attached at least in the vicinity of an edge of the fifth surface adjacent to the first surface, wherein
the fifth surface of the optical element has an area smaller than an area of the light emitting surface of the solid light emitting element,
whereby light generated from the solid light emitting element enters into the optical element through the first surface and is emitted to an outside through the fifth surface after being either reflected by any one of the first to fourth surfaces and the reflection film of the solid light emitting element or unreflected by the first to fourth surfaces and the reflection film.

20. A light source device comprising:
a solid light emitting element forming a surface emission light source having a reflection film arranged on a back side of the surface emission light source and a light emitting surface arranged on the front side of the surface emission light source;
an optical element having a first surface opposing the light emitting surface of the solid light emitting element through a gap, second and third surfaces opposing each other in parallel and being substantially perpendicular to the first surface, a fourth surface substantially perpendicular to the second and third surfaces and being inclined and opposed to the first surface and a fifth surface having a rim formed by respective side edges of the first to fourth surfaces, the optical element defining a polyhedral space surrounded by the first to fifth surfaces and filled up with a medium having a refractive index larger than a refractive index of an exterior medium surrounding the optical element, the optical element having a protecting member attached at least in the vicinity of an edge of the fifth surface adjacent to the first surface; and
a light pipe made from a medium having a refractive index larger than the refractive index of the medium in the optical element and successively formed integrally with the optical element at the fifth surface of the optical element, the light pipe having a configuration tapered so as to gradually increase its cross sectional area as departing from the optical element and having a leading surface formed in parallel with the fifth surface to provide an emission end face, wherein
the fifth surface of the optical element has an area smaller than an area of the light emitting surface of the solid light emitting element,
whereby light generated from the solid light emitting element enters into the optical element through the first surface and successively enters into the light pipe through the fifth surface after being either reflected by any one of the first to fourth surfaces and the reflection film of the solid light emitting element or unreflected by the first to fourth surfaces and the reflection film, and finally, the light is emitted to an outside through the emission end face of the light pipe.

21. The light source device of claim 19, wherein
the fourth surface is a curved surface.

22. The light source device of claim 19, wherein
the fourth surface has a surface opposing the solid light emitting element, which comprises:
a concave cylindrical surface shaped to be concave to the first surface and positioned close to the fifth surface;
an inflection point arranged at an intermediate point of the surface; and
a convex cylindrical surface shaped to be convex to the first surface and positioned apart from the fifth surface.

23. The light source device of claim 19, wherein
the fourth surface or the fourth surface and a surface of the light pipe succeeding to the fourth surface are formed with a reflection surface made of a reflecting material.

24. The light source device of claim 20, wherein
the light pipe is provided, on the emission end face, with either a reflecting deflection plate or the reflecting deflection plate and a quarter-wave plate.

25. An image display device comprising:
the light source device of claim 19;
a spatial light modulating element illuminated by light emitted from the light source device; and
an imaging optics that receives light transmitted through the spatial light modulating element thereby to produce an image of the spatial light modulating element.

26. A method of manufacturing an optical element formed as a polyhedron having a plurality of surfaces and filled up with a solid medium, the method comprising, in forming an acute-angled edge between one surface of the plurality of surfaces and the other surface opposed and inclined to the one surface:
attaching a protecting member at least in the vicinity of the acute-angled edge of the other surface after grinding the other surface; and
forming the one surface by grinding the one surface together with a part of the protecting member.
